(19) United States
(12) Patent Application Publication
(10) Pub. No.: US 2024/0192946 A1
(43) Pub. Date: Jun. 13, 2024

(54) APPLICATION MANAGEMENT PLATFORM FOR HYPER-CONVERGED CLOUD INFRASTRUCTURES

(71) Applicant: NVIDIA Corporation, Santa Clara, CA (US)

(72) Inventors: Vishvesh VIJAYWARGIYA, Bangalore (IN); Lalit ADITHYA V, Bangalore (IN); Krishnan DURAISAMY, San Jose, CA (US); Rohit RAJANI, Shajapur (IN); Gopi VADLAMUDI, Fremont, CA (US); Andrew STOCK, Placentia, CA (US); Alexander PELAVIN, Palo Alto, CA (US); Shivam MISHRA, Sacramento, CA (US); Prathik KOTIAN, Coimbatore (IN)

(21) Appl. No.: 18/416,320

(22) Filed: Jan. 18, 2024

Related U.S. Application Data
(63) Continuation of application No. 18/580,236, filed on Jan. 1, 0001.
(60) Provisional application No. 63/230,645, filed on Aug. 6, 2021.

(51) Int. Cl. G06F 8/65

(52) U.S. Cl. CPC G06F 8/65

(57) ABSTRACT

An application management platform comprising at least a packaging and bundling component, a deployment management component, and an update component. The packaging and bundling component versions, packages, and bundles a plurality of infrastructure components for a remote data center. The deployment management component provisions one or more nodes of the remote data center with the plurality of infrastructure components for an application. The update component monitors available updates to one or more of the plurality of infrastructure components used by the remote data center and facilitates update of the one or more of the plurality of infrastructure components at the remote data center.

### RELATED APPLICATIONS

This application is a continuation U.S. application Ser. No. 18/580,236, which is a 371 of International Application No. PCT/US2022/039525, filed Aug. 5, 2022, which claims benefit of priority to U.S. Provisional Application No. 63/230,645, filed Aug. 6, 2021, both of which are incorporated herein by reference in their entirety.

### TECHNICAL FIELD

At least one embodiment pertains to software versioning and deployment. Embodiments relate to automated continuous integration and continuous deployment (CI/CD) pipelines used to version and package infrastructure components for a data center.

### BACKGROUND

Hyper-converged infrastructure (HCI) is a software-defined infrastructure model that typically includes virtualization various infrastructure components of a data center. Initiation of a remote data center with a HCI often involves packaging, distributing, and in some instances upgrading a plurality of disparate infrastructure components of the remote data center. The disparate infrastructure components are often developed asynchronously in multiple fields by different teams and/or vendors. The plurality of disparate infrastructure components may include networking, storage, compute, security, and provisioning components, to name a few. In order to provision, configure, and deploy a new data center remotely, the plurality of infrastructure components is typically versioned, packaged, and distributed to the remote data center. Unfortunately, versioning, packaging, and distributing the different components as one unit is a complex and manual process, and there are no solutions available in the industry that are capable of managing data center components cohesively.

In some attempts, each of the plurality of infrastructure components are converted into software containers. This causes the production of multiple distinct containers for each component, each of which contains all files necessary for the respective infrastructure component in a unique distinct image. Such use of containerized data center components isolates each infrastructure component from the remainder of the infrastructure components. Each container associated with a respective infrastructure component is then distributed to a location of the remote data center. However, as the number of managed data centers increases, the management of multiple containers associated with each data center becomes extremely complex and inefficient.

In other attempts, the plurality of infrastructure components are cloned into a unified workspace, and the unified workspace is archived into a single distributed file that is distributed to a location of the remote data center. The customer may use the single distributed file to manually provision the remote data center with the infrastructure components. In the event different infrastructure components of the remote data center need to be updated, the plurality of infrastructure components would need to be cloned into an updated unified workspace with updated infrastructure components and further archived into an updated single distributed file to be distributed to the location of the remote data center for update. As a result, separation of the updated infrastructure components from the plurality of infrastructure components is difficult to achieve. Thus, the single distributed file is limited to starting operations when a new data cluster is created, and is unsuitable for upgrading an existing data center since the single distributable file workflow is heavy and requires disruption as there is no way to upgrade the remote data center incrementally.

Accordingly, as set forth above, embodiments of the present invention provide solutions that include the use of automated pipelines to version and package individual components, publish them to a repository, and then create a distributable artifact repository bundle using all the disparate components. The single artifact repository solution can then be conveniently shipped to remote sites using an over-the-air workflow. In contrast to previous approaches, such an artifact repository solution is lightweight and can be shipped over the air, downloaded easily, and allows in-place upgrade without any disruption.

Additionally, embodiments of the present invention include an artifact repository based solution that is capable of bundling the heterogeneous types of versioned packages as a single unit using a floating tag associated with each versioned package, ship it to a remote network over-the-air, set up or replace existing repositories, and support new versions of components. According to some embodiments, solutions as presented also allow rolling back the data center to previous (e.g., n−1 and n−2) versions.

To solve the problem of provisioning and managing HCI data center components efficiently, embodiments of the present invention use a package artifact repository—also known as a repository. Such a solution elegantly packages versioned individual components first, populates an internal artifact repository automatically, and then creates a distributable container. This all-in-one container includes components able to set up the artifact repository at a remote cluster.

### BRIEF DESCRIPTION OF DRAWINGS

Various embodiments in accordance with the present disclosure will be described with reference to the drawings, in which:

FIG. 1 illustrates an example data center system, according to at least one embodiment;

FIG. 2 illustrates an application management platform, in accordance with at least one embodiment;

FIG. 3 illustrates a packaging and bundling component of the application management platform, in accordance with at least one embodiment;

FIG. 4 illustrates provisioning of a command node of a remote data center, in accordance with at least one embodiment;

FIG. 5 illustrates a deployment manager component of the application management platform, in accordance with at least one embodiment;

FIG. 6 is a sequence diagram illustrating a method of provisioning remaining nodes of the remote data center, in accordance with at least one embodiment;

FIG. 7 illustrates an update component of the application management platform, in accordance with at least one embodiment;

FIG. 8 is a sequence diagram illustrating a method of identifying updates for nodes of the remote data center, in accordance with at least one embodiment;

FIG. 9 illustrates a computer system, according to at least one embodiment;

FIG. 10 illustrates a computer system, according to at least one embodiment;

FIG. 11 illustrates at least portions of a graphics processor, according to one or more embodiments;

FIG. 12 illustrates at least portions of a graphics processor, according to one or more embodiments;

FIG. 13 is an example data flow diagram for an advanced computing pipeline, in accordance with at least one embodiment;

FIG. 14 is a system diagram for an example system for training, adapting, instantiating and deploying machine learning models in an advanced computing pipeline, in accordance with at least one embodiment;

FIGS. 15A and 15B illustrate a data flow diagram for a process to train a machine learning model, as well as client-server architecture to enhance annotation tools with pre-trained annotation models, in accordance with at least one embodiment;

FIG. 16 illustrates a top-level service hierarchy, in accordance with at least one embodiment.

### DETAILED DESCRIPTION

Described herein are methods, systems, circuits, and apparatuses for versioning, packaging, and bundling individual infrastructure components into a distributable container (e.g., application management platform). For example, the methods, systems, circuits, and apparatuses described herein may execute automated continuous integration and continuous deployment (CI/CD) pipelines to validate events (e.g., submission or update) related to each individual component in a data center. The CI/CD pipeline includes a series of steps or operations (e.g., validation, code compilation, file linking, etc.) performed to deliver and install a new version of the individual component to a data center. Such operations may be performed to deploy one or more new clusters and/or resources in a data center and/or to update existing clusters and/or resources. Responsive to merging of the submission or update of an individual component, the individual component is versioned, built, and packaged. The versioned and packaged individual component is uploaded (e.g., stored) in an internal artifact repository. Each versioned and packaged individual component uploaded to the internal artifactory may be tagged with a user-defined floating tag, which is shared among the plurality of the individual components. The floating tag is defined according to the status of the versioned package of the individual component (e.g., ready to test, quality assurance certified, security certified or other events qualifying the release, etc.). Accordingly, each individual component may include various versioned packages each with a different tag. Specific versions of each individual component are bundled into a distributable container based on a specified tag (e.g., a specified floating tag). Each distributable container may be versioned and tagged with a user-defined tag. The distributable container may be a Kubernetes-native, full life cycle container that secures containerized applications from development to production (e.g., a Nexus Container). The distributable container may be uploaded to a public artifact repository accessible by a customer of the remote data center. The distributable container may be included in an optical disc image (e.g., ISO image) further including a base operating system (OS) (e.g., UNIX or LINUX based operating system) and an automated installer. The ISO image may be used to install the application management platform at a remote data center.

In one embodiment, processing logic generates, for each execution of a continuous integration and continuous delivery/deployment (CI/CD) pipeline of individual infrastructure components to be deployed at a data center, a unique, versioned package of each individual infrastructure component. Processing logic stores each unique versioned package of each individual infrastructure component in an internal artifact repository. Processing logic identifies a specified unique versioned package of each individual infrastructure component from the internal artifact repository. Processing logic aggregates the specified unique versioned package of each of the individual infrastructure components into a distributable container. Accordingly, processing logic may version and then package each individual component to be included in a single distributable container. As a result, individual infrastructure components may be individually updated without the need to be packaged into individual containers. This can result in reduced complexity and maximal efficiency for use within a remote data center.

Further described herein are methods, systems, circuits, and apparatuses for deploying, provisioning, and managing resources in a remote data center. For example, the methods, systems, circuits, and apparatuses described herein may use a provisioned command node of a remote data center to automate the provisioning of the remaining nodes of the remote data center. The command node may include a deployment manager and one or more services (e.g., configuration management and provisioning tools). The deployment manager refers to a set of Kubernetes operators that provision and manage a set of resources on the plurality of nodes of the remote data center. In particular, each custom controller of an operator receives a custom resource definition declaring a target state of the resource to identify differences between a current state of the resource and a target state of the resource. As a result, the custom controller synchronizes the current state of the resource to the target state of the resource. The provisioning tools (e.g., Foreman) may install a base OS on the remaining nodes of the remote data center, and the configuration management tools (e.g., AWX) may configure the remaining nodes of the remote data center. The set of resources may include top-level services (e.g., a cluster service, a storage service, a metadata service, etc.) each including one or more dependent resources (e.g., a package manager, a node configuration service, and a security configuration services). One or more resources of the set of resources may represent a logical unit of a service.

Responsive to a request from an end-user of the remote data center, the deployment manager identifies a cluster (e.g., a subset of the plurality of nodes) of the remote data center to automate the provisioning and management of one or more resources associated with an application or computing platform. The deployment management identifies a top-level service among the one or more resources to be provisioned (e.g., installed or deployed) on the cluster. The custom controller of the operator associated with the top-level services determines that a current state of the cluster does not match the target state of the cluster (e.g., the cluster is empty or does not include the top-level service). The custom controller associated with the top-level service synchronizes the current state of the cluster associated with the top-level service with the target state of the cluster associated with the top-level service, which may include installing the dependent resources associated with the top-level service to the cluster. As a result, the deployment manager generates a custom resource definition (CRD) for each of the dependent resources associated with the top-level service and provides the generated CRD to the custom controllers associated with each of the dependent resources. The custom controllers associated with the dependent resources synchronize the current state of the cluster associated with the dependent resources with the target state of the cluster associated with the dependent resources. Once all the dependent resources are completed, the top-level services completion status is updated, thereby providing the end-user a notification that the top-level services has been provisioned to the cluster.

In one embodiment, processing logic receives, by a data plane of a deployment manager, a request to provision a top-level service on a node of a remote data center. Processing logic identifies, by the data plane, a dependent resource associated with the top-level service, wherein the top-level service is dependent on the dependent resource. Processing logic provides, by the data plane, a custom resource definition associated with the dependent resource to a custom controller associated with the dependent resource to provision the node of the remote data center with the dependent resource. Responsive to provisioning of the node with the dependent resource, processing logic receives, by a control plane of the deployment manager, a notification that the top-level service is provisioned on a node. The deployment manager then automatically provisions the remaining nodes of the remote data center without intervention by the end-user (e.g., without the end-user manually provisioning each node with each resource). This can result in reduced complexity and maximal efficiency in provisioning of the remaining nodes of the remote data center.

Further described herein are methods, systems, circuits, and apparatuses for monitoring and updating resources of one or more cluster of a remote data center. For example, the methods, systems, circuits, and apparatuses described herein may use a provisioned command node of a remote data center to monitor and update resources of one or more cluster of a remote data center. The command node may include a cluster version operator in communication with a public server to monitor available updates for resources. In particular, the cluster version operator monitors a container of a public service that contains a directed acyclic graph (DAG), generated based on metadata associated with the resources from the public repository, which represents all possible update paths available for each of the resources. The container may further include a policy engine to define one or more policies for each version of the resources and may apply the one or more policies to the DAG. Accordingly, the cluster version operator may analyze the DAG and corresponding policies to determine whether there is an available update for one or more resources provisioned on the plurality of nodes of the data center. The cluster version operator may automatically generate a request to submit to a deployment manager of the command node to provision the cluster based on the available updates. The deployment manager, responsive to receiving the request from the cluster version operator, may provision (e.g., update) the cluster with the updated resource.

In one embodiment, processing logic identifies, by a client-side update component (e.g., the cluster version operator), one or more provisioned resources of a plurality of nodes of a remote data center. For each provisioned resource of the one or more provisioned resources, processing logic identifies, by the client-side update component, an available update of the provisioned resource based on a resource graph associated with the provisioned resource depicting update paths of the provisioned resource. Responsive to identifying the available update, processing logic provides, using the client-side update component, a custom resource definition associated with the available update of the provisioned resource to a custom controller associated with the provisioned resource to update one or more of the plurality of nodes of the remote data center with the updated provisioned resource. As a result, the cluster version operator periodically monitors and identifies available updates for each resource (e.g., individual component) and provides the updated individual component to the deployment manager to be updated and/or provisioned at a node of the remote data center without intervention by the user (e.g., without a user requesting a unified workspace of all individual infrastructure components and separating the updated individual infrastructure components from the unified workspace to manually update and/or provision the remote data center). This can result in reduced complexity and maximal efficiency in updating nodes of the remote data center.

### Data Center

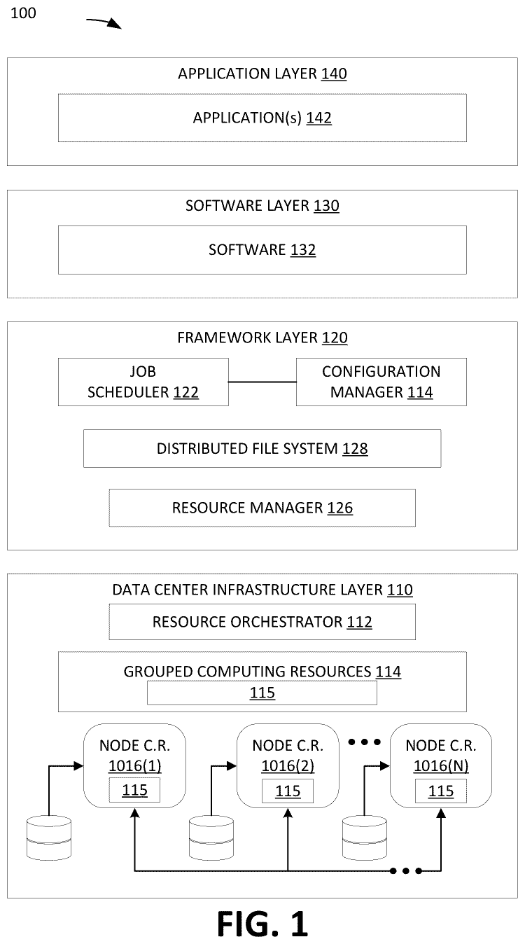

FIG. 1 illustrates an example data center 100, in which at least one embodiment may be used. In at least one embodiment, data center 100 includes a data center infrastructure layer 110, a framework layer 120, a software layer 130, and an application layer 140.

In at least one embodiment, as shown in FIG. 1, data center infrastructure layer 110 may include a resource orchestrator 112, grouped computing resources 114, and node computing resources (“node C.R.s”) 116(1)-116(N), where “N” represents any whole, positive integer. In at least one embodiment, node C.R.s 116(1)-116(N) may include, but are not limited to, any number of central processing units (“CPUs”) or other processors (including accelerators, field programmable gate arrays (FPGAs), graphics processors, etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C.R.s from among node C.R.s 116(1)-116(N) may be a server having one or more of above-mentioned computing resources.

In at least one embodiment, grouped computing resources 114 may include separate groupings of node C.R.s housed within one or more racks (not shown), or many racks housed in data centers at various geographical locations (also not shown). Separate groupings of node C.R.s within grouped computing resources 114 may include grouped compute, network, memory or storage resources that may be configured or allocated to support one or more workloads. In at least one embodiment, several node C.R.s including CPUs or processors may grouped within one or more racks to provide compute resources to support one or more workloads. In at least one embodiment, one or more racks may also include any number of power modules, cooling modules, and network switches, in any combination.

In at least one embodiment, resource orchestrator 112 may configure or otherwise control one or more node C.R.s 116(1)-116(N) and/or grouped computing resources 114. In at least one embodiment, resource orchestrator 112 may include a software design infrastructure (“SDI”) management entity for data center 100. In at least one embodiment, resource orchestrator may include hardware, software or some combination thereof.

In at least one embodiment, as shown in FIG. 1, framework layer 120 includes a job scheduler 122, a configuration manager 124, a resource manager 126 and a distributed file system 122. In at least one embodiment, framework layer 120 may include a framework to support software 132 of software layer 130 and/or one or more application(s) 142 of application layer 140. In at least one embodiment, software 132 or application(s) 142 may respectively include web-based service software or applications, such as those provided by Amazon Web Services, Google Cloud and Microsoft Azure. In at least one embodiment, framework layer 120 may be, but is not limited to, a type of free and open-source software web application framework such as Apache Spark™ (hereinafter “Spark”) that may utilize distributed file system 128 for large-scale data processing (e.g., “big data”). In at least one embodiment, job scheduler 122 may include a Spark driver to facilitate scheduling of workloads supported by various layers of data center 100. In at least one embodiment, configuration manager 124 may be capable of configuring different layers such as software layer 130 and framework layer 120 including Spark and distributed file system 128 for supporting large-scale data processing. In at least one embodiment, the configuration manager 124 may perform one or more operations described below with regards to deployment, configuration, updating, etc. In at least one embodiment, resource manager 126 may be capable of managing clustered or grouped computing resources mapped to or allocated for support of distributed file system 128 and job scheduler 122. In at least one embodiment, clustered or grouped computing resources may include grouped computing resource 114 at data center infrastructure layer 110. In at least one embodiment, resource manager 126 may coordinate with resource orchestrator 112 to manage these mapped or allocated computing resources.

In at least one embodiment, software 132 included in software layer 130 may include software used by at least portions of node C.R.s 116(1)-116(N), grouped computing resources 114, and/or distributed file system 128 of framework layer 120. The one or more types of software may include, but are not limited to, Internet web page search software, e-mail virus scan software, database software, and streaming video content software.

In at least one embodiment, application(s) 142 included in application layer 140 may include one or more types of applications used by at least portions of node C.R.s 116(1)-116(N), grouped computing resources 114, and/or distributed file system 128 of framework layer 120. One or more types of applications may include, but are not limited to, any number of a genomics application, a cognitive compute, and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 124, resource manager 126, and resource orchestrator 112 may implement any number and type of self-modifying actions based on any amount and type of data acquired in any technically feasible fashion. In at least one embodiment, self-modifying actions may relieve a data center operator of data center 100 from making possibly bad configuration decisions and possibly avoiding underutilized and/or poor performing portions of a data center.

In at least one embodiment, data center 100 may include tools, services, software or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to data center 100. In at least one embodiment, trained machine learning models corresponding to one or more neural networks may be used to infer or predict information using resources described above with respect to data center 100 by using weight parameters calculated through one or more training techniques described herein.

In at least one embodiment, data center may use CPUs, application-specific integrated circuits (ASICs), GPUs, FPGAs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

Such components can be used to generate synthetic data imitating failure cases in a network training process, which can help to improve performance of the network while limiting the amount of synthetic data to avoid overfitting.

### Application Management Platform

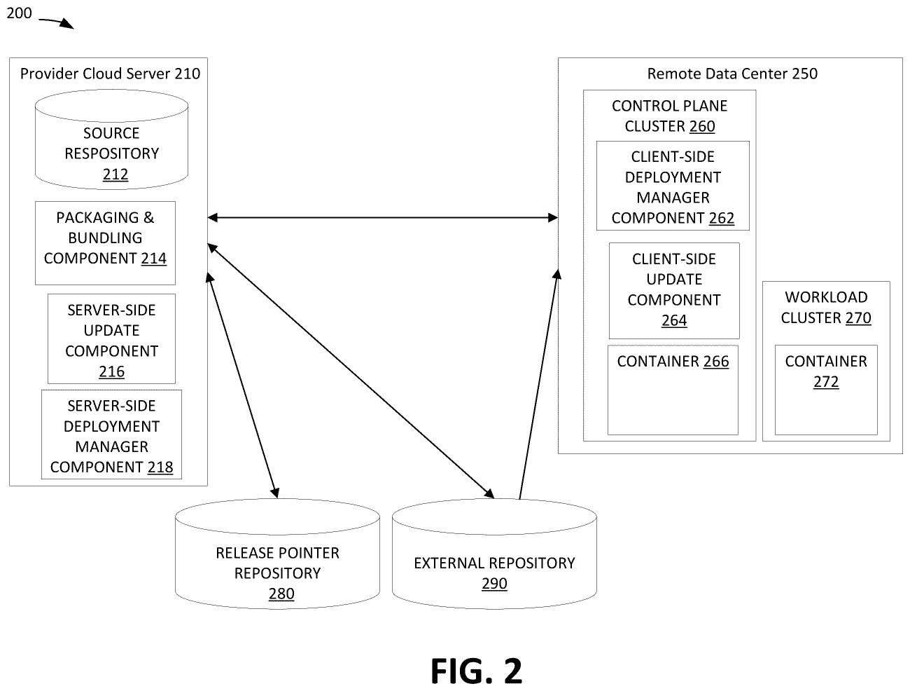

FIG. 2 illustrates an application management platform 200. The application management platform 200 may include a plurality of components dispersed between a provider cloud server 210 and a remote data center 250. In particular, the provider cloud server 310 includes a packaging and bundling component 214, a server-side update component 216, and a server-side deployment manager component 218 (e.g., a deployment manager control plane) and the remote data center 250 includes a client-side deployment manager component 262 (e.g., a deployment manager data plane) and a client-side update component 264.

In one or more embodiments, provisioning or managing components of remote data center 250 (e.g., of an HCI data center) may include a deployment manager implemented as a logical set of Kubernetes native operators (e.g., controllers+CRDs) that will govern the set of resources that are to be provisioned and managed. In one or more example implementations, one, some, or all of the resources of the set of resources represents a logical unit of a service. For example, a cluster resource represents a named cluster with its own service constructs—nodes, node configurations and other configurable applications in the cluster. In one or more example implementations, a top-level resource may be used to represent a service. For e.g., Cluster Service, Storage Service, Metadata Service, and so on are top-level services. According to some embodiments, resources may be hierarchical—that is, a resource may be composed of other resources. Depending on the embodiment, the application layer, software layer and/or framework layer may correspond to one or more hierarchical resources, for example, top-level resources and/or dependent resources as will be discussed in greater detail below.

The application management platform 200 may identify various disparate infrastructure components necessary to set up and/or update remote data center 250. The various disparate infrastructure components may include networking components, compute components, storage components, security components, versioning components, provisioning components, etc. The various disparate infrastructure components may further include automation source code, system configurations, and various types of package installations used to implement a sequence of complex workflows to set up the remote data center 250. Each of the various disparate infrastructure components may be developed by different developers under different timelines. Accordingly, at any given time, a latest version of one or more of the infrastructure components may change. These various disparate infrastructure components are stored in a source artifact repository 212 once developed by the developers. Depending on the embodiments, the source artifact repository 212 may be part of or separate from the provider cloud server 210.

The application management platform 200 may utilize the packaging and bundling component 214 to version, package, and bundle the various disparate infrastructure components into a distributable container. In particular, the packaging and bundling component 214 versions each of the various disparate infrastructure components. The packaging and bundling component 214 packages each of the various disparate infrastructure components by performing a build on each of the various disparate infrastructure components previously versioned. Once each of the various disparate infrastructure components are versioned and packaged, they are published (e.g., stored) in the external artifact repository 290. In some embodiments, the packaging and bundling component 214 may publish (e.g., stores) a release pointer associated with each of the various disparate infrastructure components that are versioned, packaged, and published into a release pointer artifact repository 280.

The packaging and bundling component 214 may selectively bundle specific packaged versions of each of the various disparate infrastructure components from the external artifact repository 290 into a distributable container. The packaging and bundling component 214 versions each distributable container and publishes (e.g., stores) the versioned distributable container using the external artifact repository 290.

In some embodiments, the application management platform 200 may utilize the packaging and bundling component 214 to create an image (e.g., an ISO image) including a versioned distributable container which can be provided to a customer of the remote data center 250 and/or to a node of the remote data center 250 to set up the remote data center 250. The ISO image may also include components of the application management platform 200 to be deployed at the remote data center 250 to assist in provisioning of the remote data center 250, such as the client-side deployment manager component 262.

The customer may utilize the ISO image prepared by the application management platform 200 to set up and provision a node of the remote data center 250. In one or more embodiments, the node set up and provisioned using the ISO image is designated the command node 260. The command node 260, once set up and provisioned, may include the client-side deployment manager component 262, the client-side update component 264, and a container 266 storing the versioned distributable container.

The customer may submit a request via the server-side deployment manager component 218 of the application management platform 200 to set up and provision a cluster (e.g., a workload cluster 270) for an application. Alternatively, such a request may be automatically generated without user input.

The server-side deployment manager component 218 may send the request to the client-side deployment manager component 262. The client-side deployment manager component 262 may identify a top-level service (or resource) associated with the application and their respective dependent resources. The client-side deployment manager component 262 may provision the workload cluster 270 with the dependent resources and any necessary infrastructure components from the container 266 based on the identified top-level service and dependent resources. Once the dependent resources and necessary infrastructure components are set up and provisioned to the workload cluster 270, the client-side deployment manager component 262 is notified that the top-level service is provisioned on the workload cluster 270 with a container 272 storing the versioned distributable container. The client-side deployment manager component 262 may notify the server-side deployment manager component 218 that the workload cluster is set up and provisioned for the application.

In some embodiments, the application management platform 200 may utilize the client-side update component 264 to periodically monitor available updates to one or more infrastructure components used by the command node and workload cluster 270. In some embodiments, the customer and/or processing logic may decline to periodically or automatically monitor available updates, and instead opt to manually trigger the client-side update component 264. The client-side update component 264 may interact with the server-side update component 216 to obtain a directed acyclic graph (DAG) based on metadata associated with the various disparate infrastructure components from the external artifact repository 290, which represents all possible update paths available for each of the various disparate infrastructure components. The client-side update component 264 may identify an available update for one or more of the various disparate infrastructure components based on the DAG, and download the specific packaged version associated with the available update from the external artifact repository 290. Once downloaded, the client-side update component 264 may utilize the client-side deployment management component 262 to update one or more of the various disparate infrastructure components in each cluster (e.g., control plane cluster and/or workload cluster) using one or more of the various disparate infrastructure components.

According to example embodiments, the server-side deployment manager component 218 may be implemented with two logical components—a control plane and a data plane. In one embodiment, a control plane may be implemented to include one or more of the following features or characteristics: components that are part of the user facing experience, user interface application (e.g., optionally backed by standardized, versioned REST application programming interfaces (APIs)), resource provider (RP) components (e.g., where each service owner provides an RP component, and a deployment provider (e.g., an adapter that handles the requests between a service API and a deployment manager data plane service). In one or more embodiments, a data plane may be implemented to include one or more of the following features or characteristics: a set of components that form the backend for the Service resources, part of the administrative control plane, and/or one or more RPs (e.g., that will call the deployment manager data plane endpoints to create resource requests). In one or more embodiments, one or more components of the control plane may be deployed using an administration cluster (e.g., one per data center or a multiple network scoped instances per data center).

### Packaging and Bundling of Infrastructure Components

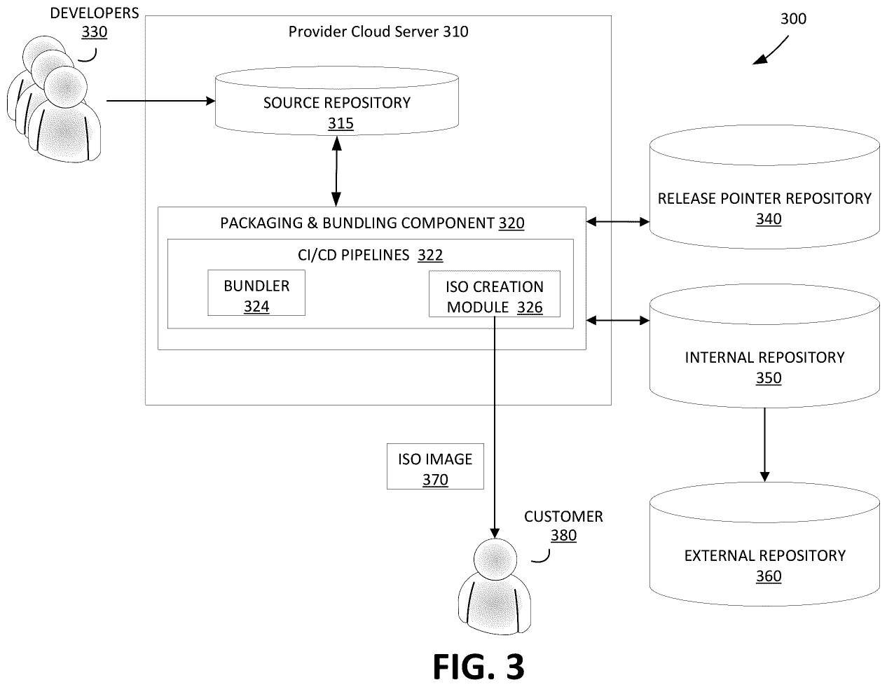

FIG. 3 illustrates a packaging and bundling component 320 of the application management platform 300 for packaging and bundling various disparate infrastructure components. As previously noted, the various disparate infrastructure components may include networking, storage, compute, security, versioning, and provisioning components.

The application management platform 300 includes a provider cloud server 310 similar to provider cloud server 210 of FIG. 2, a release pointer artifact repository 340 similar to release pointer artifact repository 280 of FIG. 2, an internal artifact repository 350, and an external artifact repository 360 similar to external artifact repository 290 of FIG. 2.

The provider cloud server 310 may include a source artifact repository 315 and a packaging and bundling component 320 similar to packaging and bundling component 214 of FIG. 2. The packaging and bundling component 320 may include a continuous integration and continuous delivery (CI/CD) pipeline 322. The CI/CD pipeline 322 may further include a bundler 324 and an ISO creation module 326.

Developers 330 may develop a plurality of infrastructure components (e.g., the various infrastructure components previously described). As previously described, the plurality of infrastructure components may include networking components, compute components, storage components, security components, provisioning components, automation source code, system confirmations, and various types of package installations used to implement a sequence of complex workflows used to set up a remote data center. The plurality of infrastructure components may be of different types, such as Debian (e.g., a Linux package), Helm (a collection of packaged Kubernetes YAMLs), Docker containers (e.g., an executable package of software), Ansible playbooks (e.g., automation tasks), other types of automation, etc.

Responsive to the developers 330 submitting a merge request (or pull request) to submit one or more developed version of an infrastructure component of the plurality of infrastructure components to the source artifact repository 315, the CI/CD pipeline 322 performs a pre-merge validation on each developed version of the infrastructure component. Pre-merge validation may include one or more of sanity checks, security checks, validation, code compilation, file linking, etc. Once pre-merge validation is completed and each developed version of the infrastructure component is merged into a main branch of their respective infrastructure component (e.g., latest version of the infrastructure component), the CI/CD pipeline 322 performs a post-merge workflow. The post-merge workflow may include, for example, versioning, building, packaging, tagging, and publishing of the latest version of the infrastructure component.

In particular, in embodiments the post-merge workflow of the CI/CD pipeline starts by creating a new version value or identifier to assign to the latest version of the infrastructure component. In one embodiment, each version value or identifier may be dictated by Semantic Versioning (SemVer) which provides a 3-component number in the format of X.Y.Z, in which X stands for a major version, Y stands for minor version, and Z stands for patches. Major versions may be reserved for major architectural updates and/or new source code, which in some cases may be manually identified by developers 330. Minor versions may be reserved for minor updates, which in most cases may be automatically increased by the post-merge workflow. Patches may be reserved for hot fixes, which in some cases may be manually identified by developers 330.

The post-merge workflow of the CI/CD pipeline builds and packages the latest version of the infrastructure component (e.g., versioned package of the infrastructure component). The post-merge workflow may publish the versioned package of the infrastructure component to the internal artifact repository 350. The internal artifact repository 350 may be part of or separate from the provider cloud server 310, but may be inaccessible to customer (or remote data center owner) 380. The internal artifact repository 350 may be configured to support uploading and storage of different types of infrastructure components as well as provide various functionality, including access control, versioning, upload security checks, and cluster functionality. The external artifact repository 360 may be configured to support uploading and storage of different types of infrastructure components as well as provide various functionality, including access control, versioning, upload security checks, and cluster functionality.

In one or more embodiments, each versioned package of the infrastructure component published to the internal artifact repository 350 may be assigned a floating tag, (e.g., a user-defined floating tag). The floating tag may indicate a status of each versioned package of the infrastructure component. Various different floating tags may be used. In some embodiments, some or all versioned packages of the infrastructure component is assigned a unique floating tag. Thus, each infrastructure component may include various versioned packages with different floating tags. Some examples of floating tags include ready to test, quality assurance certified, security certified, or other tags associated with events qualifying the release of the versioned package of the infrastructure component. The floating tag of each versioned package of the infrastructure component may be updated in response to successful completion of a specific task (e.g., validation, quality assurance certification, security certification, etc.).

For example, once the versioned package of the infrastructure component is published to the internal artifact repository 350, a “ready to test” floating tag may be assigned to the versioned package of the infrastructure component. Upon successful validation (or quality assurance testing) of the versioned package of the infrastructure component, the floating tag of the versioned package of the infrastructure component may be updated from “ready to test” to “quality assurance certified.” Upon successful security testing of the versioned package of the infrastructure component, the floating tag of the versioned package of the infrastructure component may be updated from “quality assurance certified” to “security certified.”

The bundler 324 may receive a request to bundle (i.e., perform aggregating of) the plurality of infrastructure components. The request may identify a unique floating tag to govern the selection of a versioned package of each infrastructure component of the plurality of the infrastructure components. The bundler 324 may identify each versioned package of each infrastructure component assigned the unique floating tag (e.g., identified versioned package of the infrastructure component). Once the bundler 324 obtains each identified versioned package of the infrastructure component of the plurality of infrastructure components, the bundler 324 downloads one or more identified versioned package(s) of the infrastructure component of the plurality of infrastructure components from the internal artifact repository 350. In some embodiments, only a single versioned package of each infrastructure component will have a particular floating tag. Accordingly, processing logic may bundle all packages having the specified floating tag. In some embodiments, multiple versioned package of an infrastructure component may have the same floating tag. In such an instance, for each infrastructure component processing logic may select the highest versioned package of that infrastructure component having the indicated floating tag. The bundler 324 bundles the identified versioned packages of the infrastructure components of the plurality of infrastructure components downloaded from the internal artifact repository 350 into one or more distributable containers. In one or more embodiments, the distributable container(s) may be a Kubernetes-native full life cycle container, such as a Nexus container.

In some embodiments, the bundler 324 may automatically bundle the plurality of infrastructure components based on a predetermined floating tag (e.g., “security certified” floating tag). In particular, responsive to an update of a floating tag assigned to a versioned package of the infrastructure component to the predetermined floating tag, the bundler may be triggered to automatically bundle the plurality of infrastructure components based on the predetermined floating tag. Accordingly, the bundler 324 identifies a versioned package of each infrastructure component assigned the predetermined floating tag (e.g., identified versioned package of the infrastructure component). Once the bundler 324 obtains the identified versioned packages of the plurality of infrastructure components, the bundler 324 downloads each identified versioned package of the infrastructure component of the plurality of infrastructure components from the internal artifact repository 350. The bundler 324 bundles each identified, versioned package of the infrastructure component of the plurality of infrastructure components downloaded from the internal artifact repository 350 into a distributable container. The distributable container may be a Kubernetes-native full life cycle container, such as a Nexus container.

Each distributable container created by the bundler 324 is assigned a release version. Each release version may be dictated by SemVer. Accordingly, major versions and patches may be manually indicated and minor versions may be automatically increased by the bundler 324 in some embodiments. The bundler 324 may publish each versioned distributable container to the internal artifact repository 350. Each versioned distributable container may be assigned a unique floating tag. Accordingly, each container may include various versions with different floating tags. The floating tags may include ready to test, read to distribute, and/or tags associated with other events qualifying the release of the container.

The floating tag of each versioned distributable container may be updated in response to successful completion of a specific task (e.g., validation). For example, once a versioned distributable container is published to the internal artifact repository 350, a “ready to test” floating tag may be assigned to the versioned container. Upon successful validation (or quality assurance testing) of the versioned container, the floating tag of the versioned distributable container may be updated from “ready to test” to “ready to distribute.”

Responsive to updating of the floating tag of a versioned distributable container from “ready to test” to “ready to distribute,” the bundler 324 may publish the versioned distributable container to the external artifact repository 360. The external artifact repository 360 may be part of or separate from the provider cloud server 310 and directly accessible by customer 380. Depending on the embodiment, the bundler 324 may publish a release pointer associated with a versioned distributable container published to a release pointer artifact repository 340. In particular, the release pointer may refer to a specific versioned distributable container published in the external artifact repository 360.

In some embodiments, customer 380 may designate and provide a set of requirements to the cloud server for a remote data center (not shown) intended to be deployed by the customer 380. Alternatively, such a set of requirements may be automatically determined. The optical disc (“ISO”) creation module 326 may analyze the set of requirements and generate a bootable ISO image containing a base operating system (OS) (e.g., UNIX or Linux), an installer, and the versioned container.

In some embodiments, the set of requirements may designate a floating tag to govern the selection of a versioned container. In some embodiments, the ISO creation module 326 may automatically designate a predetermined floating tag to govern the selection of the versioned container. The ISO creation module 326 may identify the versioned distributable container assigned the floating tag (or predetermined floating tag) (e.g., identified versioned container). The ISO creation module 326 may download the identified versioned distributable container from the internal artifact repository 350 for inclusion in the ISO image. Once the bootable ISO image is generated, the ISO creation module 326 may distribute the bootable ISO image directly to customer 380 to be installed on a node of a plurality of nodes (e.g., a command node) of the remote data center (not shown).

### Provisioning of a Remote Data Center

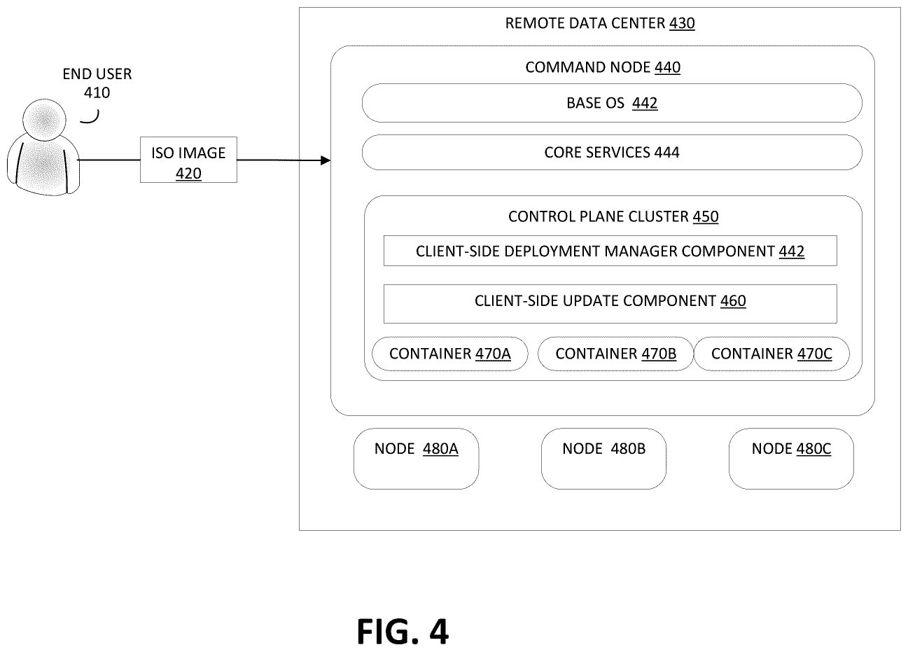

FIG. 4 illustrates provisioning of a command node of a remote data center using a bootable ISO image generated by the application management platform according to some embodiments. A customer 410 may receive a bootable ISO image 420 generated by the packaging and bundling component 214 of FIG. 2 or the packaging and bundling component 320 of FIG. 3. The customer 410 may insert ISO image 420 in a node of the remote data center 430, similar to remote data center 250 of FIG. 2 in which the customer 410 designates as a command node 440 of the remote data center 430. Alternatively, such designation of a command node 440 and insertion of the ISO image 420 to the designated node may be performed automatically without user input. The command node 440 is responsible for provisioning the remaining nodes (e.g., nodes 480A-C) of the remote data center 430. The bootable ISO image 420 may trigger installation of a base OS 442 on the command node 440. In some embodiments, the bootable ISO image 420 may further trigger installation of the base OS on the remaining nodes of the remote data center 430, for example nodes 480A-C.

Once the base OS is installed on the command node, an automation script of the ISO image may automatically trigger the installer to install core services 444. The core services 444 refers to any services necessary to implement one or more of the plurality of infrastructure components. Non-limiting examples of core service 444 may include Foreman and AWX. In some embodiments, the core service 444 may also include an Ansible Ansible tower for managing Ansible-based automation, which supports the creation of automated workflows. Once the core services 444 are installed, the automation script installs the infrastructure components of the distributable container of the bootable ISO image 420 on the command node using the core resources 444. In some embodiments, a local container (e.g., a Nexus container) 470A may be deployed in the remote data center 430 to download the distributable container. In an illustrative example, OS provisioning is performed on the command node 440 based on the automation script, causing Foreman to install OS related infrastructure components (e.g., Debian). Device, network, and storage configuration may be performed on the command node 440 based on the automation script, causing AWX to install Docker container related infrastructure components. Once the infrastructure components are installed on the command node 440, the automation script of the bootable ISO image 420 may utilize Kubeadm to create and launch a control plane cluster 450 (e.g., an administrative Kubernetes (K8S) Cluster) in the command node 440. In particular, Kubernetes setup is performed using Kubespray and respective tooling. In some embodiments, application deployment and monitoring deployment may be installed using one or more Helm charts (e.g., a Kubernetes package manager). The control plane cluster 450 may be a high availability K8S cluster. A high availability K8S cluster refers to a group of nodes (e.g., computers) that can be reliably utilized with a minimum amount of downtime. For example, more than one node (e.g., 3 nodes) may be used as the control plane cluster 450. In some embodiments, the automation script of the bootable ISO image 420 may further deploy, in the control plane cluster 450, a client-side deployment manager component 452 similar to the client-side deployment manager component 262 of FIG. 2 to deploy and manage the plurality of infrastructure components in the remaining nodes (e.g., nodes 480A-C) and a client side update component 460 similar to the client-side update component 264 of FIG. 2 to identify updates to the plurality of infrastructure components in the remaining nodes (e.g., nodes 480A-C).

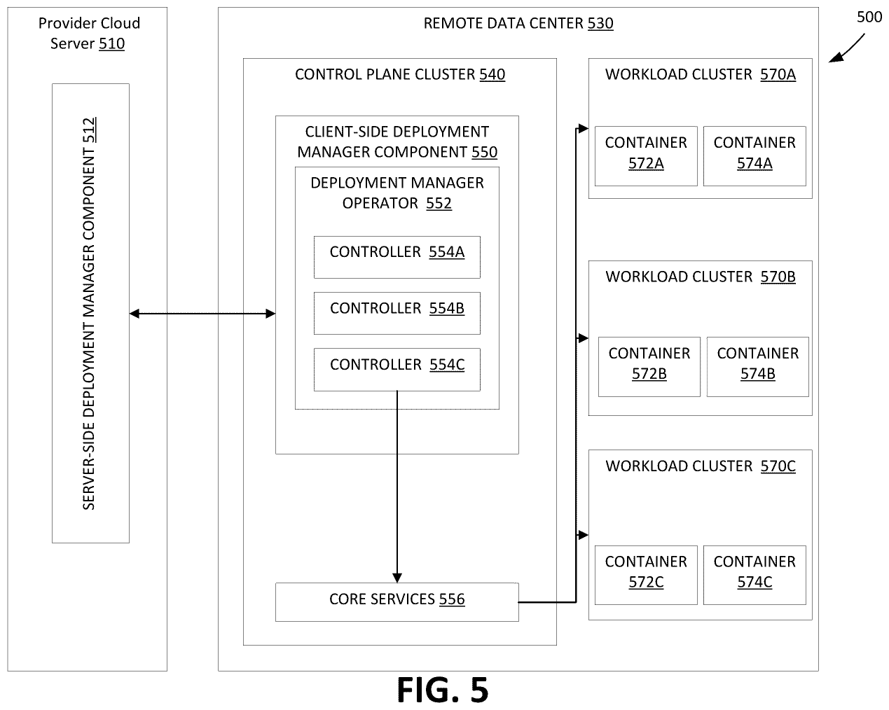

FIG. 5 illustrates a deployment manager component 500 of the application management platform. The deployment manager component 500 includes a server-side deployment manager component 512 similar to the server-side deployment manager component 262 of FIG. 2 and a client-side deployment manager component 550 similar to the client-side deployment manager component 262 of FIG. 2. In embodiments, the deployment manager 500 is configured to provision and manage the plurality of infrastructure components in workload clusters 570A-C each including one or more containers (e.g., container 572A and 574A for workload cluster 570A, container 572B and 574AB for workload cluster 570B, and container 572C and 574C for workload cluster 570C) using a service in response to a request to provision a workload cluster (e.g., workload cluster 570A) for an application. Each service may include one or more dependent resources necessary to provision the workload cluster.

The server-side deployment manager component 512, located at the provider cloud server 510, may include a front-end (e.g., a user interface (UI)) associated with a back-end (e.g., an application programming interface (API), such as a RESTful API (rest API)). The API interacts with a deployment manager provider (e.g., a K8S provider—not shown) of the server-side deployment manager component 512 used to handle requests between the API and the client-side deployment manager component 670.

The client-side deployment manager component 550 may include a deployment manager operator 552 to manage a plurality of service-related controllers (e.g., controllers 618A-C). An operator may be implemented using logic that performs a method of packaging, deploying, and managing an application (or service) (e.g., a Kubernetes application). In an illustrative example, the operator is an application-specific controller that extends the functionality of the Kubernetes API to create, configure, and manage instances and the entire life cycle of complex applications on behalf of a Kubernetes user. The operator may include a controller and custom resource definition. The operator, in particular the controller of the operator, implements control loops that repeatedly compare a desired target state of a cluster to its actual state. If the cluster's actual state does not match the target state, then the controller takes action to fix the problem. In embodiments, the operator uses custom resources (CR) to manage applications (or services) and their components. In some instances, high-level configuration and settings may be provided using a CR, which is translated by the operator into one or more low-level actions, based on best practices embedded within the operator's logic. A custom resource definition (CRD) may define a CR and lists out the entire configuration available to the operator. Accordingly, in embodiments the operator watches a CR type and takes application-specific actions to make the current state match the desired state in that resource. The operator may further monitor the application (or service) as it runs, and can back up data, recover from failures, and update the application over time, automatically.

Accordingly, controllers 618A-C may be provided by the developer of a service. Controller 554A may be a top-level controller associated with the service. The developer may dictate (via custom resources) that the top-level controller associated with the service may depend upon one or more controllers (e.g., controller 618B and controller 618C) associated with dependent resources of the top-level services (or service). Thus, for each dependent (or child) resource, the owner of the service may provide a dependent (or child) controller as a controller of the one or more controllers. In an illustrative example, top-level services may be a cluster service with dependent resources, such as (for example and without limitation) one or more files of a Helm application, node configuration, or security configuration. Each of the dependent resources may be dependent on a core service for execution.

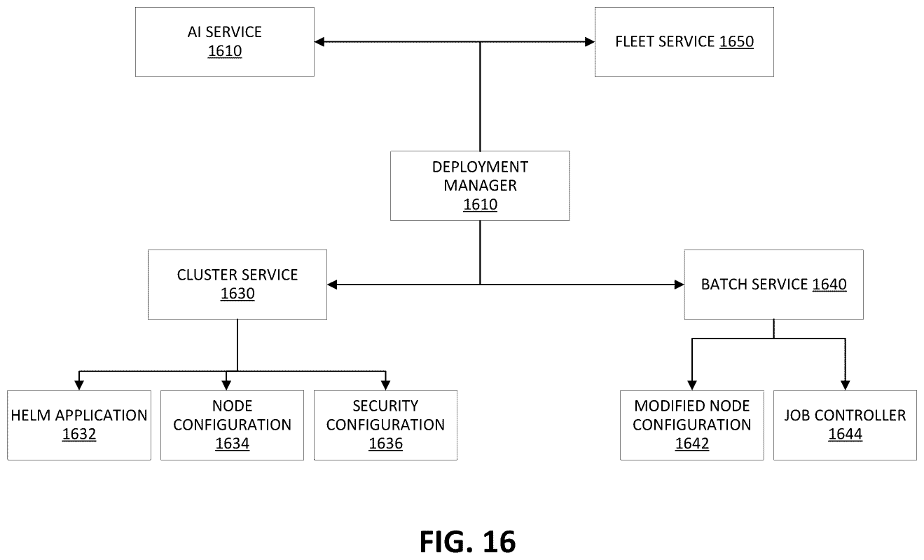

With quick reference to FIG. 16, a deployment manager 1610, similar to deployment manager component 500 of FIG. 5, is configured to provision and manage the plurality of infrastructure components in workload clusters 570A-C using a service in response to a request to provision a workload cluster (e.g., workload cluster 570A) for an application. The deployment manager 1610 may provision one or more top-level services, such as (for example and without limitation): AI service 1620, cluster service 1630, batch service 1640, and fleet service 1650. As previously described, each of the top-level services may include dependent resources. For example, cluster service 1630 may include a Helm application 1632, a node configuration 1634, and a security configuration 1636. Each of these dependent resources are necessary to provision the top-level service (e.g., cluster service 1630).

In some embodiments, one top-level service may include dependent resources that override the dependent resources of another top-level service. For example, batch service 1640 may include dependent resources, such as a modified node configuration 1642 and a job controller 1644. The modified node configuration 1642 of batch service 1640 may be a dependent resource used to override a default node configuration 1634 of cluster service 1630. In some embodiments, dependent resources may vary in type between top-level services, for example, job controller 1644 of batch service 1640 may be a type of Helm application (e.g., Helm application 1632 of cluster service).

Thus, for example, the one or more operators may include a cluster service operator, a Helm application operator, a node configuration operator, and a security configuration operator in an example. In some embodiments, an operator for each core services 556 (e.g. an Ansible job operator associated with AWX) may also be included.

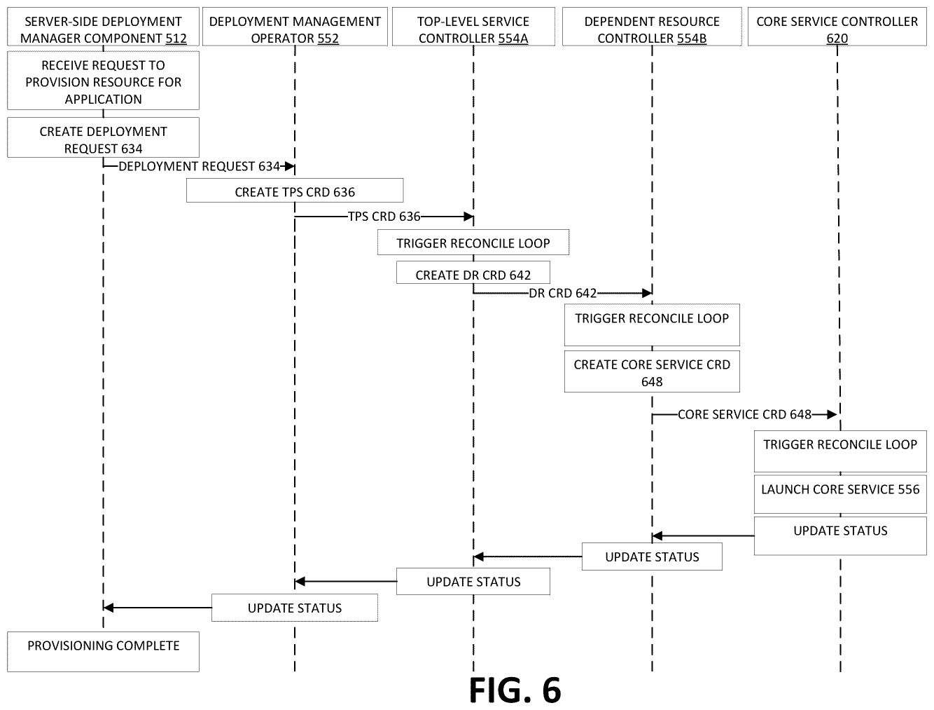

FIG. 6 is a sequence diagram illustrating a method for provisioning remaining nodes of the remote data center from the command node, in accordance with embodiments of the present disclosure. A customer of the remote data center 530 may submit a request to provision a cluster (e.g., workload cluster 570A) for an application using a front-end (e.g., a user interface (UI)) of the server-side deployment manager component 512 associated with the back-end (e.g., an application programming interface (API), such as a RESTful API (rest API)) of the server-side deployment manager component 512. The back-end interacts with a deployment manager provider (e.g., a K8S provider) of the server-side deployment manager component 512 used to handle requests between the server-side deployment manager component 512 and the deployment management operator 552 of the deployment manager 550.

The back-end may create a resource provisioning request associated with the request. The resource provisioning request is provided to a deployment manager provider of the server-side deployment manager component 512. The deployment manager provider of the server-side deployment manager component 512 creates a deployment request 634 based on the resource provisioning request (e.g., the identified top-level service and/or resource (e.g., a cluster service)) and provides the deployment request 634 to the deployment manager operator 552 of the deployment manager 550.

A deployment management controller of the deployment manager operator 552 identifies a top-level service controller 554A associated with the identified top-level service and/or resource (e.g., a cluster service) of the deployment request 634. The deployment management controller of the deployment manager operator 552 creates a top-level service custom resource definition (CRD) 636 designating a target state of the top-level service (e.g., cluster service). The top-level service controller 554A receives the top-level service CRD 636 from the deployment manager operator 552. Responsive to receiving the top-level service CRD 636 from the deployment manager operator 552, the top-level service controller 554A triggers a reconcile loop.

The reconcile loop examines an actual state of a service and/or resource (e.g., a top-level service) and compares it to the designated target state of the service and/or resource. Based on the comparison(s), the reconcile loop determines necessary steps to be performed in order to bring the actual state of the service and/or resource to the designated target state of the service and/or resource. Once determined, the reconcile loop performs the necessary steps and updates the actual state of the service and/or resource to the designated target state of the service and/or resource. Once the necessary steps are performed and the actual state of the service and/or resource is updated to the designated target state of the service and/or resource, the reconcile loop updates a status of the operator (e.g., top-level service operator) indicating that the actual state of the service and/or resource was updated to the designated target state of the service and/or resource. In some embodiments, the reconcile loop determines that the necessary steps to be performed in order to bring the actual state of the service and/or resource to the designated target state of the service and/or resource includes provisioning other resources (e.g., a dependent resource) in which the service and/or resource is dependent upon. Accordingly, the reconcile loop may generate additional CRDs (e.g., a dependent resource CRD) for each dependent resource associated with the service and/or resource. The additional CRDs are provided to a controller of the other resource's operators, which may trigger another reconcile loop in the controller of the other resource's operators. The reconcile loop awaits completion of the another reconcile loop in the controller of the other resource's operators to determine the necessary steps were performed to update the actual state of the service and/or resource to the designated target state of the service and/or resource.

Once the reconcile loop is triggered by the top-level service controller 554A, the reconcile loop identifies that at least one dependent resource is necessary to update the actual state of the service and/or resource to the designated target state of the service and/or resource. The reconcile loop of the top-level service controller 554A creates a dependent resource CRD 642 designating a target state of the dependent resource. The dependent resource controller 554B receives the dependent resource CRD 642 from the top-level service controller 554A. The dependent resource controller 554B triggers a reconcile loop.

Once the reconcile loop is triggered by the dependent resource controller 554B, the reconcile loop identifies that at least one core service is necessary to update the actual state of the dependent resource to the designated target state of the dependent resource. The reconcile loop of the dependent resource controller 554B creates a core service CRD 648 designating a target state of the core service. A core service controller 620 receives the core service CRD 648 from the dependent resource controller 554B. The core service controller 620 triggers a reconcile loop. The reconcile loop of the core service controller 620 determines that at least one step of the necessary steps to update the actual state of the core service to the designated target state of the core service includes launching the core service to perform provisioning of the cluster. For example, Foreman is triggered to install OSes on the cluster. Once completed, a status of the core resource operator 620 is updated indicating that the actual state of the core resource was updated to the designated target state of the core resource. The status of the core resource operator is constantly monitored (or queried) by the dependent resource controller 554B. Responsive to determining that the status of the core resource operator 620 is updated, the status of the dependent resource controller 554B is updated indicating the core resource of the dependent resource was updated from the actual state to the designated state.

The status of the dependent resource controller 554B may be repeatedly (e.g., periodically or constantly) monitored (or queried) by the top-level service 554A in embodiments. Responsive to determining that the status of the dependent resource controller 554B is updated, the status of the top-level service controller 554A may be updated indicating the dependent resource of the top-level service was updated from the actual state to the designated state.

The status of the top-level service controller 554A is constantly monitored (or queried) by the deployment management operator 552 in embodiments. Responsive to determining that the status of the top-level service controller 554A is updated, the status of the deployment management operator 552 may be updated indicating the top-level service controller 554A was updated from the actual state to the designated state. Once the status of the deployment management operator 552 is updated indicating the top-level service controller 554A was updated from the actual state to the designated state, the deployment management operator 552 notifies the server-side deployment manager component 512 that the request to provision the cluster for the application is complete. In some embodiments, instead of the status being monitored or queried, the status is provided by the corresponding controller.

### Upgrading the Remote Data Center

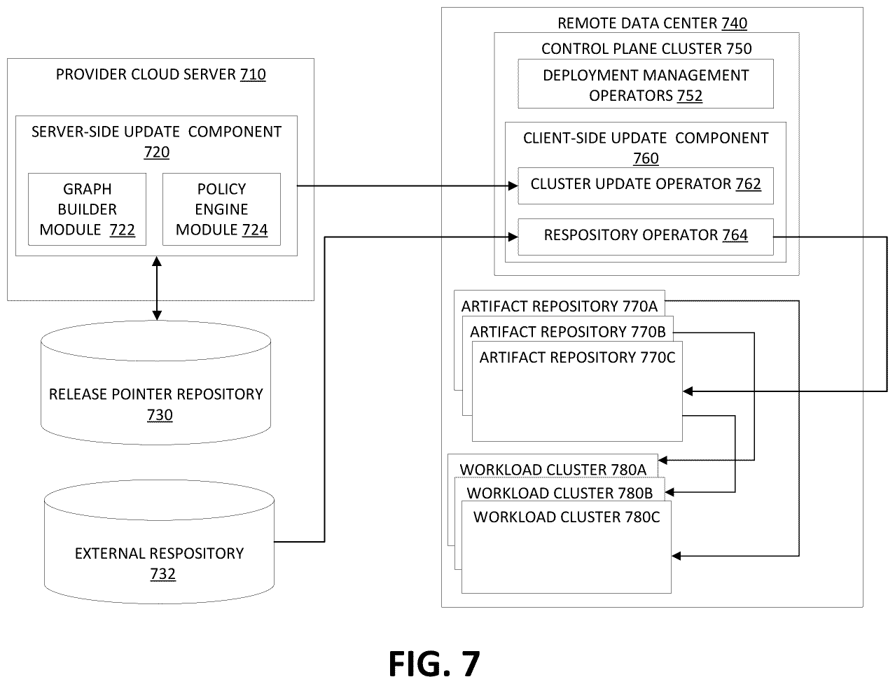

FIG. 7 illustrates an update component (e.g., server-side update component 720 and client-side update component 760) of the application management platform. The provider cloud server 710 includes the server-side update component 720, similar to server-side update component 216, configured to interact with a release pointer artifact repository 730. The release pointer artifact repository 730, similar to release pointer 280 of FIG. 2, stores a release pointer for each packaged version of each of the various disparate infrastructure components and each of the various versioned distributable containers. The external artifact repository 732, similar to external artifact repository 290 of FIG. 2, stores one or more packaged versions of each of the various disparate infrastructure components and various versioned distributable containers. The server-side update component 720 may be a container that includes a graph builder module 722 and a policy engine module 724.

The graph builder module 722 queries the release pointer artifact repository 730 for release pointers of each packaged version of each of the various disparate infrastructure components to generate a directed acyclic graph (DAG), where each node represents a version number and each edge represents an update path. In particular, a DAG is generated for each of the various disparate infrastructure components. The policy engine module 724 receives the DAG to apply policy definitions to the DAG. The policy definitions may modify the DAG to remove or alter update paths that are available to the customer based on the configuration of the remote data center 740.

The remote data center 740 includes a control plane cluster 750, a plurality of artifact repositories 770A-C, and workload clusters 780A-C. The control plane cluster 750 includes a deployment management operator 752, the client-side update component 760, and an artifact repository operator 764. The client-side update component 760, similar to client-side update component 264, using a cluster update operator 762 periodically monitors available updates to one or more infrastructure components used by control plane cluster 750 and workload clusters 780A-C by interacting with the server-side update component 720 to obtain the DAG with the various disparate infrastructure components from the release pointer artifact repository 730, which represents all possible update paths available for each of the various infrastructure components. In order to facilitate an over-the-air (OTA) update using the client-side update component 760 and the server-side update component 720, the server-side update component 720 may include a container (e.g., a sidecar container) deployed alongside the sever-side update component 720 which share resources like pod storage and network interfaces. The sidecar container can also share storage volumes with the sever-side update component 720, allowing the server-side update component 720 to access the data in the sidecar container.

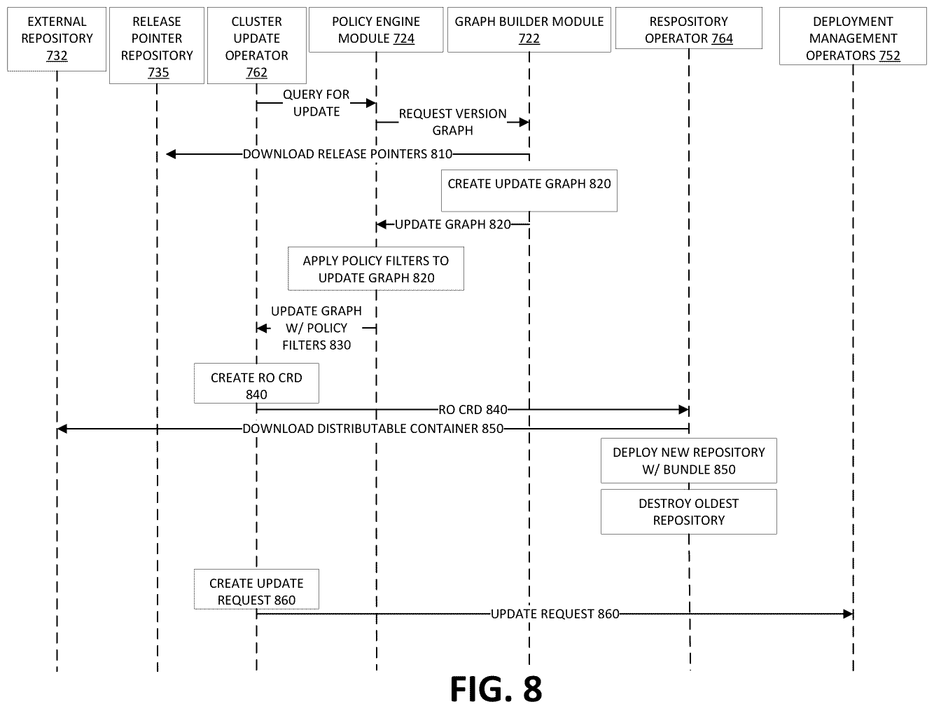

FIG. 8 is a sequence diagram illustrating a method of identifying updates for nodes of the remote data center, in accordance with embodiments of the present disclosure. The cluster update operator 762 periodically monitors available updates to one or more infrastructure components by querying updates from the policy engine module 724 of the server-side update component 720. The policy engine module 724 requests a versioned graph of each of the one or more infrastructure components from the graph builder module 722. The graph builder module 722 sends a request to a release pointer artifact repository operator 735 (e.g., an operator associated with the release pointer artifact repository 730) to obtain (e.g., download) release pointers 810 associated with each of the one or more infrastructure components from the release pointer artifact repository 730. The graph builder module 722 generates a DAG (e.g., update graph 820) for each of the one or more infrastructure components. The graph builder module 722 provides the update graph 820 to the policy engine module 724 to apply policy filters (e.g., policy definitions) to update graph 820. The update graph with policy filter 830 is provided to the cluster update operator from the policy engine module 724. The cluster update operator 762, responsive to receiving the update graph with policy filter 830, may create an artifact repository operator CRD 840 (e.g., RO CRD 840) instructing, via a target state of the RO CRD 840, to download a distributable container (e.g., distributable container 850) containing the available updates to one or more infrastructure components present in the update graph with policy filter 830. The cluster update operator 762 may provide the RO CRD 840 to the artifact repository operator 764. The artifact repository operator 764 triggers a reconcile loop which downloads the distributable container 850 from the external artifact repository 732.

In some embodiments, if there is only one artifact repository artifact repository deployed (e.g., artifact repository 770A) to the remote data center 740, the artifact repository operator 764 deploys a new artifact repository (e.g., artifact repository 770B) with the downloaded distributable container 850. Each of the deployed artifact repositories may be re-numbered in numerical order with the artifact repository having the newest distributable container starting at 1 to the artifact repository having the oldest distributable container.

In other embodiments, once a predetermined number of artifact repositories (e.g., 3) are deployed in the remote data center 740, such as artifact repositories 770A-Z, the artifact repository operator 764 deletes the artifact repository having the oldest distributable container and deploys a new artifact repository with the downloaded distributable container 850. Each of the deployed artifact repositories are re-numbered in numerical order with the artifact repository having the newest distributable container starting at 1 to the artifact repository having the oldest distributable container. Additionally and/or alternatively, the predetermined number of artifact repositories provides a mechanism for rolling back the version of the distributable containers used by the control plane cluster 750 and/or workload clusters 780A-C.

In some embodiments, the cluster update operator 762 may create an update request 860. The update request 860 may identify the specific artifact repository that includes the distributable container with the available updates to one or more infrastructure components. The update request 860 is provided to the deployment management operator 752. Accordingly, the deployment management operator 752 may process the update request similar to how the deployment management operator 552 of FIG. 5 processed the deployment request 634 of FIG. 6 to update one or more infrastructure components of control plane cluster 750 and/or workload clusters 780A-C.

### Computer Systems

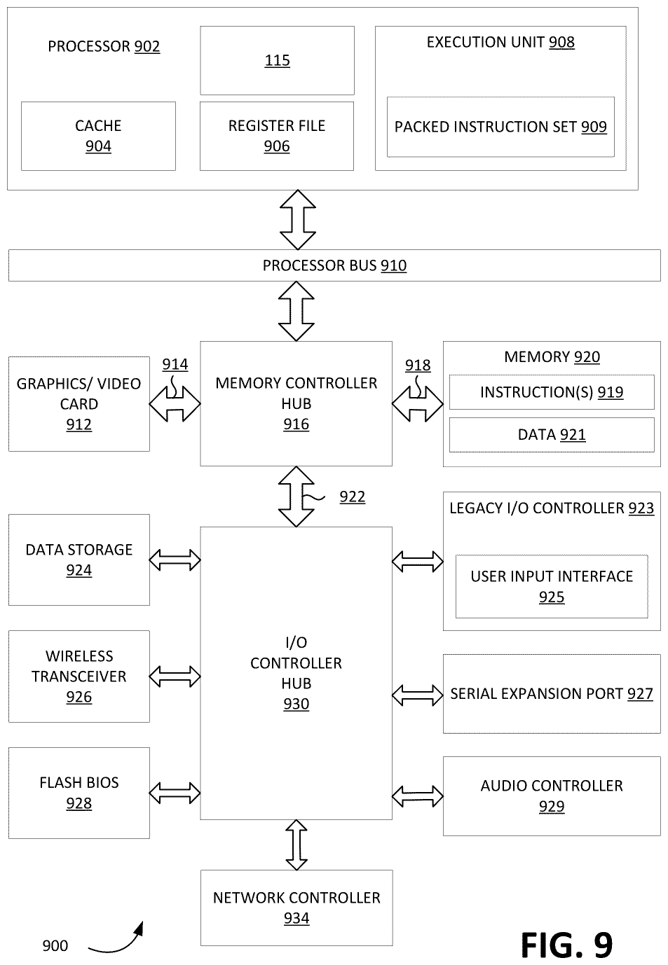

FIG. 9 is a block diagram illustrating an exemplary computer system, which may be a system with interconnected devices and components, a system-on-a-chip (SOC) or some combination thereof 900 formed with a processor that may include execution units to execute an instruction, according to at least one embodiment. In at least one embodiment, computer system 900 may include, without limitation, a component, such as a processor 902 to employ execution units including logic to perform algorithms for process data, in accordance with present disclosure, such as in embodiment described herein. In at least one embodiment, computer system 900 may include processors, such as PENTIUM® Processor family, Xeon™ Itanium®, XScale™ and/or StrongARM™, Intel® Core™, or Intel® Nervana™ microprocessors available from Intel Corporation of Santa Clara, California, although other systems (including PCs having other microprocessors, engineering workstations, set-top boxes and like) may also be used. In at least one embodiment, computer system 900 may execute a version of WINDOWS' operating system available from Microsoft Corporation of Redmond, Wash., although other operating systems (UNIX and Linux for example), embedded software, and/or graphical user interfaces, may also be used.

Embodiments may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (“DSP”), system on a chip, network computers (“NetPCs”), set-top boxes, network hubs, wide area network (“WAN”) switches, or any other system that may perform one or more instructions in accordance with at least one embodiment.

In at least one embodiment, computer system 900 may include, without limitation, processor 902 that may include, without limitation, one or more execution units 908 to perform machine learning model training and/or inferencing according to techniques described herein. In at least one embodiment, computer system 900 is a single processor desktop or server system, but in another embodiment computer system 900 may be a multiprocessor system. In at least one embodiment, processor 902 may include, without limitation, a complex instruction set computer (“CISC”) microprocessor, a reduced instruction set computing (“RISC”) microprocessor, a very long instruction word (“VLIW”) microprocessor, a processor implementing a combination of instruction sets, or any other processor device, such as a digital signal processor, for example. In at least one embodiment, processor 902 may be coupled to a processor bus 910 that may transmit data signals between processor 902 and other components in computer system 900.

In at least one embodiment, processor 902 may include, without limitation, a Level 1 (“L1”) internal cache memory (“cache”) 904. In at least one embodiment, processor 902 may have a single internal cache or multiple levels of internal cache. In at least one embodiment, cache memory may reside external to processor 902. Other embodiments may also include a combination of both internal and external caches depending on particular implementation and needs. In at least one embodiment, register file 906 may store different types of data in various registers including, without limitation, integer registers, floating point registers, status registers, and instruction pointer register.

In at least one embodiment, execution unit 908, including, without limitation, logic to perform integer and floating point operations, also resides in processor 902. In at least one embodiment, processor 902 may also include a microcode (“ucode”) read only memory (“ROM”) that stores microcode for certain macro instructions. In at least one embodiment, execution unit 908 may include logic to handle a packed instruction set 909. In at least one embodiment, by including packed instruction set 909 in an instruction set of a general-purpose processor 902, along with associated circuitry to execute instructions, operations used by many multimedia applications may be performed using packed data in a general-purpose processor 902. In one or more embodiments, many multimedia applications may be accelerated and executed more efficiently by using full width of a processor's data bus for performing operations on packed data, which may eliminate need to transfer smaller units of data across processor's data bus to perform one or more operations one data element at a time.

In at least one embodiment, execution unit 908 may also be used in microcontrollers, embedded processors, graphics devices, DSPs, and other types of logic circuits. In at least one embodiment, computer system 900 may include, without limitation, a memory 920. In at least one embodiment, memory 920 may be implemented as a Dynamic Random Access Memory (“DRAM”) device, a Static Random Access Memory (“SRAM”) device, flash memory device, or other memory device. In at least one embodiment, memory 920 may store instruction(s) 919 and/or data 921 represented by data signals that may be executed by processor 902.

In at least one embodiment, system logic chip may be coupled to processor bus 910 and memory 920. In at least one embodiment, system logic chip may include, without limitation, a memory controller hub (“MCH”) 916, and processor 902 may communicate with MCH 916 via processor bus 910. In at least one embodiment, MCH 916 may provide a high bandwidth memory path 918 to memory 920 for instruction and data storage and for storage of graphics commands, data and textures. In at least one embodiment, MCH 916 may direct data signals between processor 902, memory 920, and other components in computer system 900 and to bridge data signals between processor bus 910, memory 920, and a system I/O 922. In at least one embodiment, system logic chip may provide a graphics port for coupling to a graphics controller. In at least one embodiment, MCH 916 may be coupled to memory 920 through a high bandwidth memory path 918 and graphics/video card 912 may be coupled to MCH 916 through an Accelerated Graphics Port (“AGP”) interconnect 914.

In at least one embodiment, computer system 900 may use system I/O 922 that is a proprietary hub interface bus to couple MCH 916 to I/O controller hub (“ICH”) 930. In at least one embodiment, ICH 930 may provide direct connections to some I/O devices via a local I/O bus. In at least one embodiment, local I/O bus may include, without limitation, a high-speed I/O bus for connecting peripherals to memory 920, chipset, and processor 902. Examples may include, without limitation, an audio controller 929, a firmware hub (“flash BIOS”) 928, a wireless transceiver 926, a data storage 924, a legacy I/O controller 923 containing user input and keyboard interfaces 925, a serial expansion port 927, such as Universal Serial Bus (“USB”), and a network controller 934. Data storage 924 may comprise a hard disk drive, a floppy disk drive, a CD-ROM device, a flash memory device, or other mass storage device.

In at least one embodiment, FIG. 9 illustrates a system, which includes interconnected hardware devices or “chips,” whereas in other embodiments, FIG. 9 may illustrate an exemplary System on a Chip (“SoC”). In at least one embodiment, devices may be interconnected with proprietary interconnects, standardized interconnects (e.g., PCIe) or some combination thereof. In at least one embodiment, one or more components of computer system 900 are interconnected using compute express link (CXL) interconnects.

Inference and/or training logic 115 are used to perform inferencing and/or training operations associated with one or more embodiments. Details regarding inference and/or training logic 115 are provided below in conjunction with FIGS. 1A and/or 1B. In at least one embodiment, inference and/or training logic 115 may be used in system FIG. 9 for inferencing or predicting operations based, at least in part, on weight parameters calculated using neural network training operations, neural network functions and/or architectures, or neural network use cases described herein.

Such components can be used to generate synthetic data imitating failure cases in a network training process, which can help to improve performance of the network while limiting the amount of synthetic data to avoid overfitting.

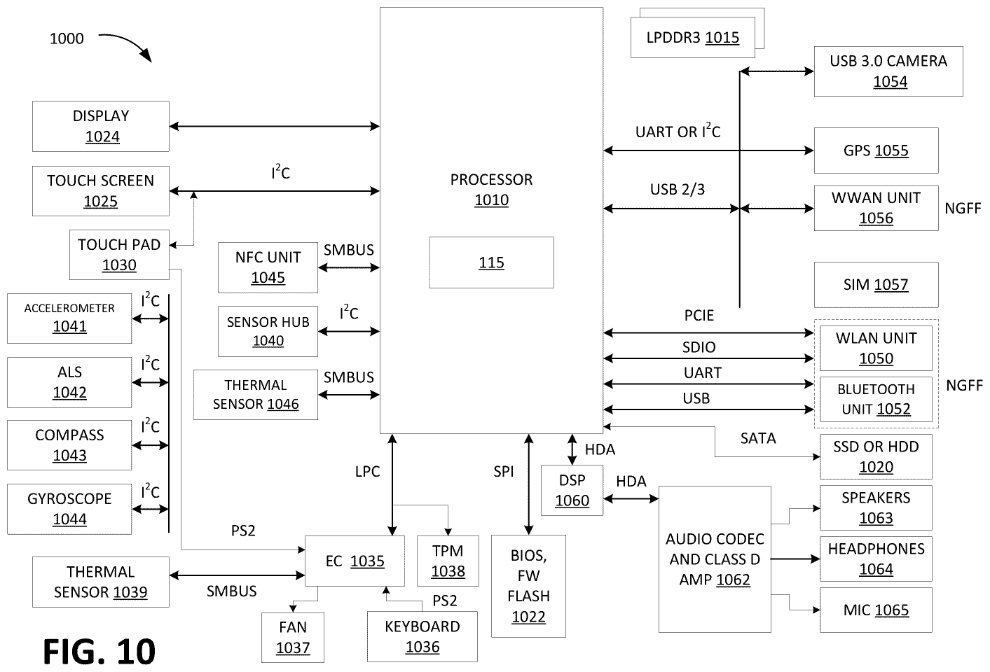

FIG. 10 is a block diagram illustrating an electronic device 1000 for utilizing a processor 1010, according to at least one embodiment. In at least one embodiment, electronic device 1000 may be, for example and without limitation, a notebook, a tower server, a rack server, a blade server, a laptop, a desktop, a tablet, a mobile device, a phone, an embedded computer, or any other suitable electronic device.

In at least one embodiment, system 1000 may include, without limitation, processor 1010 communicatively coupled to any suitable number or kind of components, peripherals, modules, or devices. In at least one embodiment, processor 1010 coupled using a bus or interface, such as a 1° C. bus, a System Management Bus (“SMBus”), a Low Pin Count (LPC) bus, a Serial Peripheral Interface (“SPI”), a High Definition Audio (“HDA”) bus, a Serial Advance Technology Attachment (“SATA”) bus, a Universal Serial Bus (“USB”) (versions 1, 2, 3), or a Universal Asynchronous Receiver/Transmitter (“UART”) bus. In at least one embodiment, FIG. 10 illustrates a system, which includes interconnected hardware devices or “chips,” whereas in other embodiments, FIG. 10 may illustrate an exemplary System on a Chip (“SoC”). In at least one embodiment, devices illustrated in FIG. 10 may be interconnected with proprietary interconnects, standardized interconnects (e.g., PCIe) or some combination thereof. In at least one embodiment, one or more components of FIG. 10 are interconnected using compute express link (CXL) interconnects.

In at least one embodiment, FIG. 10 may include a display 1024, a touch screen 1025, a touch pad 1030, a Near Field Communications unit (“NFC”) 1045, a sensor hub 1040, a thermal sensor 1046, an Express Chipset (“EC”) 1035, a Trusted Platform Module (“TPM”) 1038, BIOS/firmware/flash memory (“BIOS, FW Flash”) 1022, a DSP 1060, a drive 1020 such as a Solid State Disk (“SSD”) or a Hard Disk Drive (“HDD”), a wireless local area network unit (“WLAN”) 1050, a Bluetooth unit 1052, a Wireless Wide Area Network unit (“WWAN”) 1056, a Global Positioning System (GPS) 1055, a camera (“USB 3.0 camera”) 1054 such as a USB 3.0 camera, and/or a Low Power Double Data Rate (“LPDDR”) memory unit (“LPDDR3”) 1015 implemented in, for example, LPDDR3 standard. These components may each be implemented in any suitable manner.

In at least one embodiment, other components may be communicatively coupled to processor 1010 through components discussed above. In at least one embodiment, an accelerometer 1041, Ambient Light Sensor (“ALS”) 1042, compass 1043, and a gyroscope 1044 may be communicatively coupled to sensor hub 1040. In at least one embodiment, thermal sensor 1039, a fan 1037, a keyboard 1046, and a touch pad 1030 may be communicatively coupled to EC 1035. In at least one embodiment, speaker 1063, headphones 1064, and microphone (“mic”) 1065 may be communicatively coupled to an audio unit (“audio codec and class d amp”) 1062, which may in turn be communicatively coupled to DSP 1060. In at least one embodiment, audio unit 1064 may include, for example and without limitation, an audio coder/decoder (“codec”) and a class D amplifier. In at least one embodiment, SIM card (“SIM”) 1057 may be communicatively coupled to WWAN unit 1056. In at least one embodiment, components such as WLAN unit 1050 and Bluetooth unit 1052, as well as WWAN unit 1056 may be implemented in a Next Generation Form Factor (“NGFF”).

Inference and/or training logic 115 are used to perform inferencing and/or training operations associated with one or more embodiments. Details regarding inference and/or training logic 115 are provided below in conjunction with FIGS. 1A and/or 1B. In at least one embodiment, inference and/or training logic 115 may be used in system FIG. 10 for inferencing or predicting operations based, at least in part, on weight parameters calculated using neural network training operations, neural network functions and/or architectures, or neural network use cases described herein.

Such components can be used to generate synthetic data imitating failure cases in a network training process, which can help to improve performance of the network while limiting the amount of synthetic data to avoid overfitting.

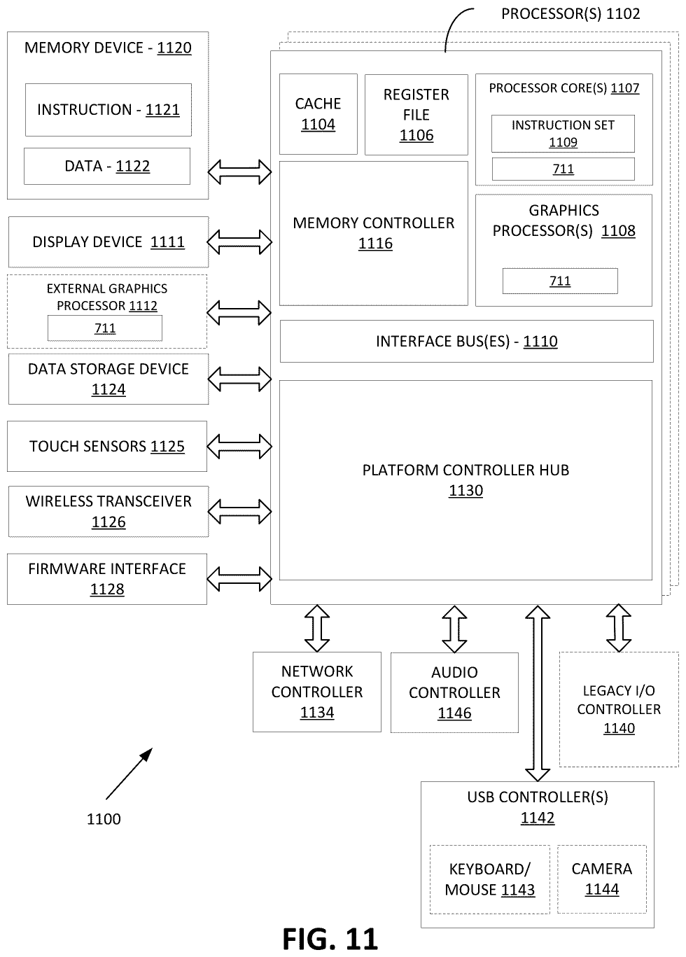

FIG. 11 is a block diagram of a processing system, according to at least one embodiment. In at least one embodiment, system 1100 includes one or more processors 1102 and one or more graphics processors 1108, and may be a single processor desktop system, a multiprocessor workstation system, or a server system having a large number of processors 1102 or processor cores 1107. In at least one embodiment, system 1100 is a processing platform incorporated within a system-on-a-chip (SoC) integrated circuit for use in mobile, handheld, or embedded devices.

In at least one embodiment, system 1100 can include, or be incorporated within a server-based gaming platform, a game console, including a game and media console, a mobile gaming console, a handheld game console, or an online game console. In at least one embodiment, system 1100 is a mobile phone, smart phone, tablet computing device or mobile Internet device. In at least one embodiment, processing system 1100 can also include, couple with, or be integrated within a wearable device, such as a smart watch wearable device, smart eyewear device, augmented reality device, or virtual reality device. In at least one embodiment, processing system 1100 is a television or set top box device having one or more processors 1102 and a graphical interface generated by one or more graphics processors 1108.

In at least one embodiment, one or more processors 1102 each include one or more processor cores 1107 to process instructions which, when executed, perform operations for system and user software. In at least one embodiment, each of one or more processor cores 1107 is configured to process a specific instruction set 1109. In at least one embodiment, instruction set 1109 may facilitate Complex Instruction Set Computing (CISC), Reduced Instruction Set Computing (RISC), or computing via a Very Long Instruction Word (VLIW). In at least one embodiment, processor cores 1107 may each process a different instruction set 1109, which may include instructions to facilitate emulation of other instruction sets. In at least one embodiment, processor core 1107 may also include other processing devices, such a Digital Signal Processor (DSP).

In at least one embodiment, processor 1102 includes cache memory 1104. In at least one embodiment, processor 1102 can have a single internal cache or multiple levels of internal cache. In at least one embodiment, cache memory is shared among various components of processor 1102. In at least one embodiment, processor 1102 also uses an external cache (e.g., a Level-3 (L3) cache or Last Level Cache (LLC)) (not shown), which may be shared among processor cores 1107 using known cache coherency techniques. In at least one embodiment, register file 1106 is additionally included in processor 1102 which may include different types of registers for storing different types of data (e.g., integer registers, floating point registers, status registers, and an instruction pointer register). In at least one embodiment, register file 1106 may include general-purpose registers or other registers.

In at least one embodiment, one or more processor(s) 1102 are coupled with one or more interface bus(es) 1110 to transmit communication signals such as address, data, or control signals between processor 1102 and other components in system 1100. In at least one embodiment, interface bus 1110, in one embodiment, can be a processor bus, such as a version of a Direct Media Interface (DMI) bus. In at least one embodiment, interface 1110 is not limited to a DMI bus, and may include one or more Peripheral Component Interconnect buses (e.g., PCI, PCI Express), memory busses, or other types of interface busses. In at least one embodiment processor(s) 1102 include an integrated memory controller 1116 and a platform controller hub 1130. In at least one embodiment, memory controller 1116 facilitates communication between a memory device and other components of system 1100, while platform controller hub (PCH) 1130 provides connections to I/O devices via a local I/O bus.

In at least one embodiment, memory device 1120 can be a dynamic random access memory (DRAM) device, a static random access memory (SRAM) device, flash memory device, phase-change memory device, or some other memory device having suitable performance to serve as process memory. In at least one embodiment memory device 1120 can operate as system memory for system 1100, to store data 1122 and instructions 1121 for use when one or more processors 1102 executes an application or process. In at least one embodiment, memory controller 1116 also couples with an optional external graphics processor 1112, which may communicate with one or more graphics processors 1108 in processors 1102 to perform graphics and media operations. In at least one embodiment, a display device 1111 can connect to processor(s) 1102. In at least one embodiment display device 1111 can include one or more of an internal display device, as in a mobile electronic device or a laptop device or an external display device attached via a display interface (e.g., DisplayPort, etc.). In at least one embodiment, display device 1111 can include a head mounted display (HMD) such as a stereoscopic display device for use in virtual reality (VR) applications or augmented reality (AR) applications.

In at least one embodiment, platform controller hub 1130 enables peripherals to connect to memory device 1120 and processor 1102 via a high-speed I/O bus. In at least one embodiment, I/O peripherals include, but are not limited to, an audio controller 1146, a network controller 1134, a firmware interface 1128, a wireless transceiver 1126, touch sensors 1125, a data storage device 1124 (e.g., hard disk drive, flash memory, etc.). In at least one embodiment, data storage device 1124 can connect via a storage interface (e.g., SATA) or via a peripheral bus, such as a Peripheral Component Interconnect bus (e.g., PCI, PCI Express). In at least one embodiment, touch sensors 1125 can include touch screen sensors, pressure sensors, or fingerprint sensors. In at least one embodiment, wireless transceiver 1126 can be a Wi-Fi transceiver, a Bluetooth transceiver, or a mobile network transceiver such as a 3G, 4G, or Long Term Evolution (LTE) transceiver. In at least one embodiment, firmware interface 1128 enables communication with system firmware, and can be, for example, a unified extensible firmware interface (UEFI). In at least one embodiment, network controller 1134 can enable a network connection to a wired network. In at least one embodiment, a high-performance network controller (not shown) couples with interface bus 1110. In at least one embodiment, audio controller 1146 is a multi-channel high definition audio controller. In at least one embodiment, system 1100 includes an optional legacy I/O controller 1140 for coupling legacy (e.g., Personal System 2 (PS/2)) devices to system. In at least one embodiment, platform controller hub 1130 can also connect to one or more Universal Serial Bus (USB) controllers 1142 connect input devices, such as keyboard and mouse 1143 combinations, a camera 1144, or other USB input devices.

In at least one embodiment, an instance of memory controller 1116 and platform controller hub 1130 may be integrated into a discreet external graphics processor, such as external graphics processor 1112. In at least one embodiment, platform controller hub 1130 and/or memory controller 1116 may be external to one or more processor(s) 1102. For example, in at least one embodiment, system 1100 can include an external memory controller 1116 and platform controller hub 1130, which may be configured as a memory controller hub and peripheral controller hub within a system chipset that is in communication with processor(s) 1102.

Inference and/or training logic 115 are used to perform inferencing and/or training operations associated with one or more embodiments. Details regarding inference and/or training logic 115 are provided below in conjunction with FIGS. 1A and/or 1B. In at least one embodiment portions or all of inference and/or training logic 115 may be incorporated into graphics processor 1500. For example, in at least one embodiment, training and/or inferencing techniques described herein may use one or more of ALUs embodied in a graphics processor. Moreover, in at least one embodiment, inferencing and/or training operations described herein may be done using logic other than logic illustrated in FIG. 1A or 1B. In at least one embodiment, weight parameters may be stored in on-chip or off-chip memory and/or registers (shown or not shown) that configure ALUs of a graphics processor to perform one or more machine learning algorithms, neural network architectures, use cases, or training techniques described herein.

Such components can be used to generate synthetic data imitating failure cases in a network training process, which can help to improve performance of the network while limiting the amount of synthetic data to avoid overfitting.

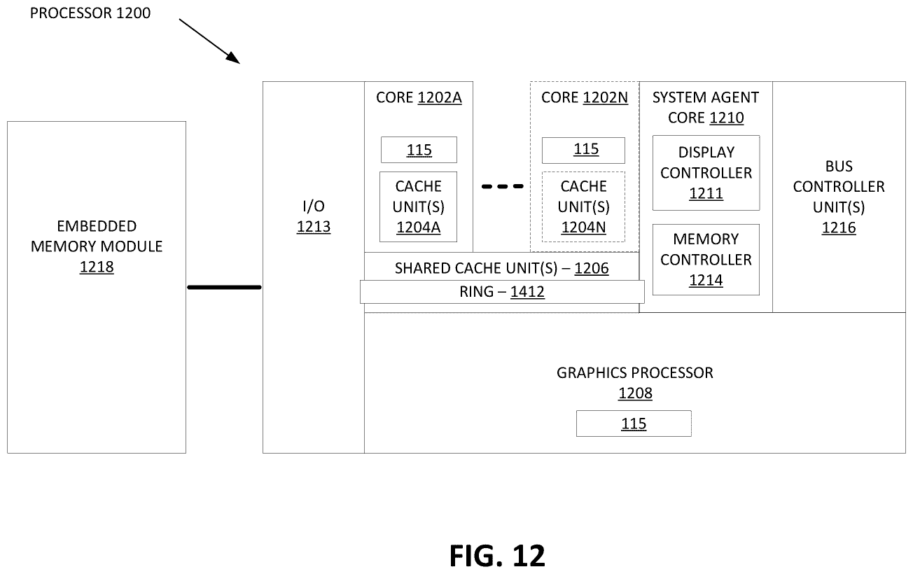

FIG. 12 is a block diagram of a processor 1200 having one or more processor cores 1202A-1202N, an integrated memory controller 1214, and an integrated graphics processor 1208, according to at least one embodiment. In at least one embodiment, processor 1200 can include additional cores up to and including additional core 1202N represented by dashed lined boxes. In at least one embodiment, each of processor cores 1202A-1202N includes one or more internal cache units 1204A-1204N. In at least one embodiment, each processor core also has access to one or more shared cached units 1206.

In at least one embodiment, internal cache units 1204A-1204N and shared cache units 1206 represent a cache memory hierarchy within processor 1200. In at least one embodiment, cache memory units 1204A-1204N may include at least one level of instruction and data cache within each processor core and one or more levels of shared mid-level cache, such as a Level 2 (L2), Level 3 (L3), Level 4 (L4), or other levels of cache, where a highest level of cache before external memory is classified as an LLC. In at least one embodiment, cache coherency logic maintains coherency between various cache units 1206 and 1204A-1204N.

In at least one embodiment, processor 1200 may also include a set of one or more bus controller units 1216 and a system agent core 1210. In at least one embodiment, one or more bus controller units 1216 manage a set of peripheral buses, such as one or more PCI or PCI express busses. In at least one embodiment, system agent core 1210 provides management functionality for various processor components. In at least one embodiment, system agent core 1210 includes one or more integrated memory controllers 1214 to manage access to various external memory devices (not shown).

In at least one embodiment, one or more of processor cores 1202A-1202N include support for simultaneous multi-threading. In at least one embodiment, system agent core 1210 includes components for coordinating and operating cores 1202A-1202N during multi-threaded processing. In at least one embodiment, system agent core 1210 may additionally include a power control unit (PCU), which includes logic and components to regulate one or more power states of processor cores 1202A-1202N and graphics processor 1208.

In at least one embodiment, processor 1200 additionally includes graphics processor 1208 to execute graphics processing operations. In at least one embodiment, graphics processor 1208 couples with shared cache units 1206, and system agent core 1210, including one or more integrated memory controllers 1214. In at least one embodiment, system agent core 1210 also includes a display controller 1211 to drive graphics processor output to one or more coupled displays. In at least one embodiment, display controller 1211 may also be a separate module coupled with graphics processor 1208 via at least one interconnect, or may be integrated within graphics processor 1208.

In at least one embodiment, a ring based interconnect unit 1212 is used to couple internal components of processor 1200. In at least one embodiment, an alternative interconnect unit may be used, such as a point-to-point interconnect, a switched interconnect, or other techniques. In at least one embodiment, graphics processor 1208 couples with ring interconnect 1212 via an I/O link 1213.

In at least one embodiment, I/O link 1213 represents at least one of multiple varieties of I/O interconnects, including an on package I/O interconnect which facilitates communication between various processor components and a high-performance embedded memory module 1218, such as an eDRAM module. In at least one embodiment, each of processor cores 1202A-1202N and graphics processor 1208 use embedded memory modules 1218 as a shared Last Level Cache.

In at least one embodiment, processor cores 1202A-1202N are homogenous cores executing a common instruction set architecture. In at least one embodiment, processor cores 1202A-1202N are heterogeneous in terms of instruction set architecture (ISA), where one or more of processor cores 1202A-1202N execute a common instruction set, while one or more other cores of processor cores 1202A-1202N executes a subset of a common instruction set or a different instruction set. In at least one embodiment, processor cores 1202A-1202N are heterogeneous in terms of microarchitecture, where one or more cores having a relatively higher power consumption couple with one or more power cores having a lower power consumption. In at least one embodiment, processor 1200 can be implemented on one or more chips or as a SoC integrated circuit.

Inference and/or training logic 115 are used to perform inferencing and/or training operations associated with one or more embodiments. Details regarding inference and/or training logic 115 are provided below in conjunction with FIGS. 1A and/or 1B. In at least one embodiment portions or all of inference and/or training logic 115 may be incorporated into processor 1200. For example, in at least one embodiment, training and/or inferencing techniques described herein may use one or more of ALUs embodied in graphics processor 1512, graphics core(s) 1202A-1202N, or other components in FIG. 12. Moreover, in at least one embodiment, inferencing and/or training operations described herein may be done using logic other than logic illustrated in FIG. 1A or 1B. In at least one embodiment, weight parameters may be stored in on-chip or off-chip memory and/or registers (shown or not shown) that configure ALUs of graphics processor 1200 to perform one or more machine learning algorithms, neural network architectures, use cases, or training techniques described herein.

Such components can be used to generate synthetic data imitating failure cases in a network training process, which can help to improve performance of the network while limiting the amount of synthetic data to avoid overfitting.

### Virtualized Computing Platform

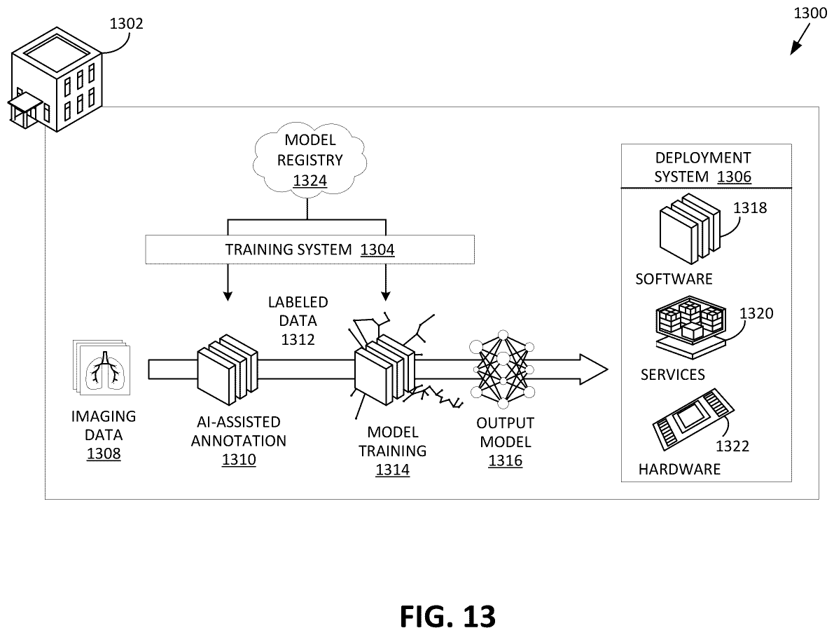

FIG. 13 is an example data flow diagram for a process 1300 of generating and deploying an image processing and inferencing pipeline, in accordance with at least one embodiment. In at least one embodiment, process 1300 may be deployed for use with imaging devices, processing devices, and/or other device types at one or more facilities 1302. Process 1300 may be executed within a training system 1304 and/or a deployment system 1306. In at least one embodiment, training system 1304 may be used to perform training, deployment, and implementation of machine learning models (e.g., neural networks, object detection algorithms, computer vision algorithms, etc.) for use in deployment system 1306. In at least one embodiment, deployment system 1306 may be configured to offload processing and compute resources among a distributed computing environment to reduce infrastructure requirements at facility 1302. In at least one embodiment, one or more applications in a pipeline may use or call upon services (e.g., inference, visualization, compute, AI, etc.) of deployment system 1306 during execution of applications.

In at least one embodiment, some of applications used in advanced processing and inferencing pipelines may use machine learning models or other AI to perform one or more processing steps. In at least one embodiment, machine learning models may be trained at facility 1302 using data 1308 (such as imaging data) generated at facility 1302 (and stored on one or more picture archiving and communication system (PACS) servers at facility 1302), may be trained using imaging or sequencing data 1308 from another facility(ies), or a combination thereof. In at least one embodiment, training system 1304 may be used to provide applications, services, and/or other resources for generating working, deployable machine learning models for deployment system 1306.

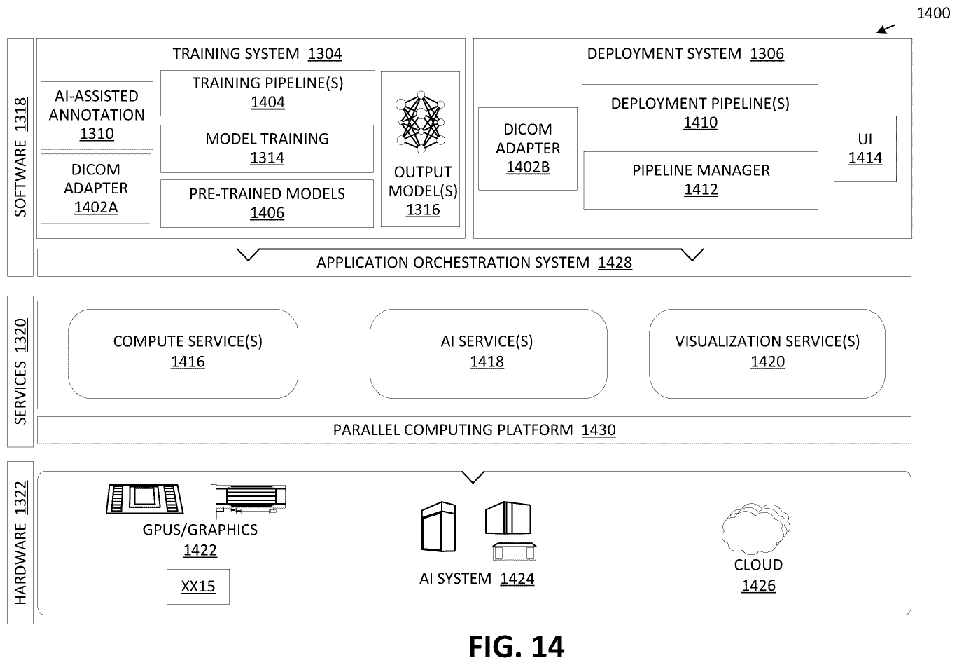

In at least one embodiment, model registry 1324 may be backed by object storage that may support versioning and object metadata. In at least one embodiment, object storage may be accessible through, for example, a cloud storage (e.g., cloud 1426 of FIG. 14) compatible application programming interface (API) from within a cloud platform. In at least one embodiment, machine learning models within model registry 1324 may uploaded, listed, modified, or deleted by developers or partners of a system interacting with an API. In at least one embodiment, an API may provide access to methods that allow users with appropriate credentials to associate models with applications, such that models may be executed as part of execution of containerized instantiations of applications.

In at least one embodiment, training pipeline 1404 (FIG. 14) may include a scenario where facility 1302 is training their own machine learning model, or has an existing machine learning model that needs to be optimized or updated. In at least one embodiment, imaging data 1308 generated by imaging device(s), sequencing devices, and/or other device types may be received. In at least one embodiment, once imaging data 1308 is received, AI-assisted annotation 1310 may be used to aid in generating annotations corresponding to imaging data 1308 to be used as ground truth data for a machine learning model. In at least one embodiment, AI-assisted annotation 1310 may include one or more machine learning models (e.g., convolutional neural networks (CNNs)) that may be trained to generate annotations corresponding to certain types of imaging data 1308 (e.g., from certain devices). In at least one embodiment, AI-assisted annotations 1310 may then be used directly, or may be adjusted or fine-tuned using an annotation tool to generate ground truth data. In at least one embodiment, AI-assisted annotations 1310, labeled clinic data 1312, or a combination thereof may be used as ground truth data for training a machine learning model. In at least one embodiment, a trained machine learning model may be referred to as output model 1316, and may be used by deployment system 1306, as described herein.

In at least one embodiment, training pipeline 1404 (FIG. 14) may include a scenario where facility 1302 needs a machine learning model for use in performing one or more processing tasks for one or more applications in deployment system 1306, but facility 1302 may not currently have such a machine learning model (or may not have a model that is optimized, efficient, or effective for such purposes). In at least one embodiment, an existing machine learning model may be selected from a model registry 1324. In at least one embodiment, model registry 1324 may include machine learning models trained to perform a variety of different inference tasks on imaging data. In at least one embodiment, machine learning models in model registry 1324 may have been trained on imaging data from different facilities than facility 1302 (e.g., facilities remotely located). In at least one embodiment, machine learning models may have been trained on imaging data from one location, two locations, or any number of locations. In at least one embodiment, when being trained on imaging data from a specific location, training may take place at that location, or at least in a manner that protects confidentiality of imaging data or restricts imaging data from being transferred off-premises. In at least one embodiment, once a model is trained—or partially trained—at one location, a machine learning model may be added to model registry 1324. In at least one embodiment, a machine learning model may then be retrained, or updated, at any number of other facilities, and a retrained or updated model may be made available in model registry 1324. In at least one embodiment, a machine learning model may then be selected from model registry 1324—and referred to as output model 1316—and may be used in deployment system 1306 to perform one or more processing tasks for one or more applications of a deployment system.

In at least one embodiment, training pipeline 1404 (FIG. 14), a scenario may include facility 1302 requiring a machine learning model for use in performing one or more processing tasks for one or more applications in deployment system 1306, but facility 1302 may not currently have such a machine learning model (or may not have a model that is optimized, efficient, or effective for such purposes). In at least one embodiment, a machine learning model selected from model registry 1324 may not be fine-tuned or optimized for imaging data 1308 generated at facility 1302 because of differences in populations, robustness of training data used to train a machine learning model, diversity in anomalies of training data, and/or other issues with training data. In at least one embodiment, AI-assisted annotation 1310 may be used to aid in generating annotations corresponding to imaging data 1308 to be used as ground truth data for retraining or updating a machine learning model. In at least one embodiment, labeled data 1312 may be used as ground truth data for training a machine learning model. In at least one embodiment, retraining or updating a machine learning model may be referred to as model training 1314. In at least one embodiment, model training 1314—e.g., AI-assisted annotations 1310, labeled clinic data 1312, or a combination thereof—may be used as ground truth data for retraining or updating a machine learning model. In at least one embodiment, a trained machine learning model may be referred to as output model 1316, and may be used by deployment system 1306, as described herein.

In at least one embodiment, deployment system 1306 may include software 1318, services 1320, hardware 1322, and/or other components, features, and functionality. In at least one embodiment, deployment system 1306 may include a software “stack,” such that software 1318 may be built on top of services 1320 and may use services 1320 to perform some or all of processing tasks, and services 1320 and software 1318 may be built on top of hardware 1322 and use hardware 1322 to execute processing, storage, and/or other compute tasks of deployment system 1306. In at least one embodiment, software 1318 may include any number of different containers, where each container may execute an instantiation of an application. In at least one embodiment, each application may perform one or more processing tasks in an advanced processing and inferencing pipeline (e.g., inferencing, object detection, feature detection, segmentation, image enhancement, calibration, etc.). In at least one embodiment, an advanced processing and inferencing pipeline may be defined based on selections of different containers that are desired or required for processing imaging data 1308, in addition to containers that receive and configure imaging data for use by each container and/or for use by facility 1302 after processing through a pipeline (e.g., to convert outputs back to a usable data type). In at least one embodiment, a combination of containers within software 1318 (e.g., that make up a pipeline) may be referred to as a virtual instrument (as described in more detail herein), and a virtual instrument may leverage services 1320 and hardware 1322 to execute some or all processing tasks of applications instantiated in containers.

In at least one embodiment, a data processing pipeline may receive input data (e.g., imaging data 1308) in a specific format in response to an inference request (e.g., a request from a user of deployment system 1306). In at least one embodiment, input data may be representative of one or more images, video, and/or other data representations generated by one or more imaging devices. In at least one embodiment, data may undergo pre-processing as part of data processing pipeline to prepare data for processing by one or more applications. In at least one embodiment, post-processing may be performed on an output of one or more inferencing tasks or other processing tasks of a pipeline to prepare an output data for a next application and/or to prepare output data for transmission and/or use by a user (e.g., as a response to an inference request). In at least one embodiment, inferencing tasks may be performed by one or more machine learning models, such as trained or deployed neural networks, which may include output models 1316 of training system 1304.

In at least one embodiment, tasks of data processing pipeline may be encapsulated in a container(s) that each represents a discrete, fully functional instantiation of an application and virtualized computing environment that is able to reference machine learning models. In at least one embodiment, containers or applications may be published into a private (e.g., limited access) area of a container registry (described in more detail herein), and trained or deployed models may be stored in model registry 1324 and associated with one or more applications. In at least one embodiment, images of applications (e.g., container images) may be available in a container registry, and once selected by a user from a container registry for deployment in a pipeline, an image may be used to generate a container for an instantiation of an application for use by a user's system.

In at least one embodiment, developers (e.g., software developers, clinicians, doctors, etc.) may develop, publish, and store applications (e.g., as containers) for performing image processing and/or inferencing on supplied data. In at least one embodiment, development, publishing, and/or storing may be performed using a software development kit (SDK) associated with a system (e.g., to ensure that an application and/or container developed is compliant with or compatible with a system). In at least one embodiment, an application that is developed may be tested locally (e.g., at a first facility, on data from a first facility) with an SDK which may support at least some of services 1320 as a system (e.g., system 1400 of FIG. 14). In at least one embodiment, because DICOM objects may contain anywhere from one to hundreds of images or other data types, and due to a variation in data, a developer may be responsible for managing (e.g., setting constructs for, building pre-processing into an application, etc.) extraction and preparation of incoming data. In at least one embodiment, once validated by system 1400 (e.g., for accuracy), an application may be available in a container registry for selection and/or implementation by a user to perform one or more processing tasks with respect to data at a facility (e.g., a second facility) of a user.

In at least one embodiment, developers may then share applications or containers through a network for access and use by users of a system (e.g., system 1400 of FIG. 14). In at least one embodiment, completed and validated applications or containers may be stored in a container registry and associated machine learning models may be stored in model registry 1324. In at least one embodiment, a requesting entity—who provides an inference or image processing request—may browse a container registry and/or model registry 1324 for an application, container, dataset, machine learning model, etc., select a desired combination of elements for inclusion in data processing pipeline, and submit an imaging processing request. In at least one embodiment, a request may include input data (and associated patient data, in some examples) that is necessary to perform a request, and/or may include a selection of application(s) and/or machine learning models to be executed in processing a request. In at least one embodiment, a request may then be passed to one or more components of deployment system 1306 (e.g., a cloud) to perform processing of data processing pipeline. In at least one embodiment, processing by deployment system 1306 may include referencing selected elements (e.g., applications, containers, models, etc.) from a container registry and/or model registry 1324. In at least one embodiment, once results are generated by a pipeline, results may be returned to a user for reference (e.g., for viewing in a viewing application suite executing on a local, on-premises workstation or terminal).

In at least one embodiment, to aid in processing or execution of applications or containers in pipelines, services 1320 may be leveraged. In at least one embodiment, services 1320 may include compute services, artificial intelligence (AI) services, visualization services, and/or other service types. In at least one embodiment, services 1320 may provide functionality that is common to one or more applications in software 1318, so functionality may be abstracted to a service that may be called upon or leveraged by applications. In at least one embodiment, functionality provided by services 1320 may run dynamically and more efficiently, while also scaling well by allowing applications to process data in parallel (e.g., using a parallel computing platform 1430 (FIG. 14)). In at least one embodiment, rather than each application that shares a same functionality offered by a service 1320 being required to have a respective instance of service 1320, service 1320 may be shared between and among various applications. In at least one embodiment, services may include an inference server or engine that may be used for executing detection or segmentation tasks, as non-limiting examples. In at least one embodiment, a model training service may be included that may provide machine learning model training and/or retraining capabilities. In at least one embodiment, a data augmentation service may further be included that may provide GPU accelerated data (e.g., DICOM, RIS, CIS, REST compliant, RPC, raw, etc.) extraction, resizing, scaling, and/or other augmentation. In at least one embodiment, a visualization service may be used that may add image rendering effects—such as ray-tracing, rasterization, denoising, sharpening, etc.—to add realism to two-dimensional (2D) and/or three-dimensional (3D) models. In at least one embodiment, virtual instrument services may be included that provide for beam-forming, segmentation, inferencing, imaging, and/or support for other applications within pipelines of virtual instruments.

In at least one embodiment, where a service 1320 includes an AI service (e.g., an inference service), one or more machine learning models may be executed by calling upon (e.g., as an API call) an inference service (e.g., an inference server) to execute machine learning model(s), or processing thereof, as part of application execution. In at least one embodiment, where another application includes one or more machine learning models for segmentation tasks, an application may call upon an inference service to execute machine learning models for performing one or more of processing operations associated with segmentation tasks. In at least one embodiment, software 1318 implementing advanced processing and inferencing pipeline that includes segmentation application and anomaly detection application may be streamlined because each application may call upon a same inference service to perform one or more inferencing tasks.

In at least one embodiment, hardware 1322 may include GPUs, CPUs, graphics cards, an AI/deep learning system (e.g., an AI supercomputer, such as NVIDIA's DGX), a cloud platform, or a combination thereof. In at least one embodiment, different types of hardware 1322 may be used to provide efficient, purpose-built support for software 1318 and services 1320 in deployment system 1306. In at least one embodiment, use of GPU processing may be implemented for processing locally (e.g., at facility 1302), within an AI/deep learning system, in a cloud system, and/or in other processing components of deployment system 1306 to improve efficiency, accuracy, and efficacy of image processing and generation. In at least one embodiment, software 1318 and/or services 1320 may be optimized for GPU processing with respect to deep learning, machine learning, and/or high-performance computing, as non-limiting examples. In at least one embodiment, at least some of computing environment of deployment system 1306 and/or training system 1304 may be executed in a datacenter one or more supercomputers or high performance computing systems, with GPU optimized software (e.g., hardware and software combination of NVIDIA's DGX System). In at least one embodiment, hardware 1322 may include any number of GPUs that may be called upon to perform processing of data in parallel, as described herein. In at least one embodiment, cloud platform may further include GPU processing for GPU-optimized execution of deep learning tasks, machine learning tasks, or other computing tasks. In at least one embodiment, cloud platform (e.g., NVIDIA's NGC) may be executed using an AI/deep learning supercomputer(s) and/or GPU-optimized software (e.g., as provided on NVIDIA's DGX Systems) as a hardware abstraction and scaling platform. In at least one embodiment, cloud platform may integrate an application container clustering system or orchestration system (e.g., KUBERNETES) on multiple GPUs to enable seamless scaling and load balancing.

FIG. 14 is a system diagram for an example system 1400 for generating and deploying an imaging deployment pipeline, in accordance with at least one embodiment. In at least one embodiment, system 1400 may be used to implement process 1300 of FIG. 13 and/or other processes including advanced processing and inferencing pipelines. In at least one embodiment, system 1400 may include training system 1304 and deployment system 1306. In at least one embodiment, training system 1304 and deployment system 1306 may be implemented using software 1318, services 1320, and/or hardware 1322, as described herein.

In at least one embodiment, system 1400 (e.g., training system 1304 and/or deployment system 1306) may implemented in a cloud computing environment (e.g., using cloud 1426). In at least one embodiment, system 1400 may be implemented locally with respect to a healthcare services facility, or as a combination of both cloud and local computing resources. In at least one embodiment, access to APIs in cloud 1426 may be restricted to authorized users through enacted security measures or protocols. In at least one embodiment, a security protocol may include web tokens that may be signed by an authentication (e.g., AuthN, AuthZ, Gluecon, etc.) service and may carry appropriate authorization. In at least one embodiment, APIs of virtual instruments (described herein), or other instantiations of system 1400, may be restricted to a set of public IPs that have been vetted or authorized for interaction.

In at least one embodiment, various components of system 1400 may communicate between and among one another using any of a variety of different network types, including but not limited to local area networks (LANs) and/or wide area networks (WANs) via wired and/or wireless communication protocols. In at least one embodiment, communication between facilities and components of system 1400 (e.g., for transmitting inference requests, for receiving results of inference requests, etc.) may be communicated over data bus(ses), wireless data protocols (Wi-Fi), wired data protocols (e.g., Ethernet), etc.

In at least one embodiment, training system 1304 may execute training pipelines 1404, similar to those described herein with respect to FIG. 13. In at least one embodiment, where one or more machine learning models are to be used in deployment pipelines 1410 by deployment system 1306, training pipelines 1404 may be used to train or retrain one or more (e.g. pre-trained) models, and/or implement one or more of pre-trained models 1406 (e.g., without a need for retraining or updating). In at least one embodiment, as a result of training pipelines 1404, output model(s) 1316 may be generated. In at least one embodiment, training pipelines 1404 may include any number of processing steps, such as but not limited to imaging data (or other input data) conversion or adaption In at least one embodiment, for different machine learning models used by deployment system 1306, different training pipelines 1404 may be used. In at least one embodiment, training pipeline 1404 similar to a first example described with respect to FIG. 13 may be used for a first machine learning model, training pipeline 1404 similar to a second example described with respect to FIG. 13 may be used for a second machine learning model, and training pipeline 1404 similar to a third example described with respect to FIG. 13 may be used for a third machine learning model. In at least one embodiment, any combination of tasks within training system 1304 may be used depending on what is required for each respective machine learning model. In at least one embodiment, one or more of machine learning models may already be trained and ready for deployment so machine learning models may not undergo any processing by training system 1304, and may be implemented by deployment system 1306.

In at least one embodiment, output model(s) 1316 and/or pre-trained model(s) 1406 may include any types of machine learning models depending on implementation or embodiment. In at least one embodiment, and without limitation, machine learning models used by system 1400 may include machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoders, convolutional, recurrent, perceptrons, Long/Short Term Memory (LSTM), Hopfield, Boltzmann, deep belief, deconvolutional, generative adversarial, liquid state machine, etc.), and/or other types of machine learning models.

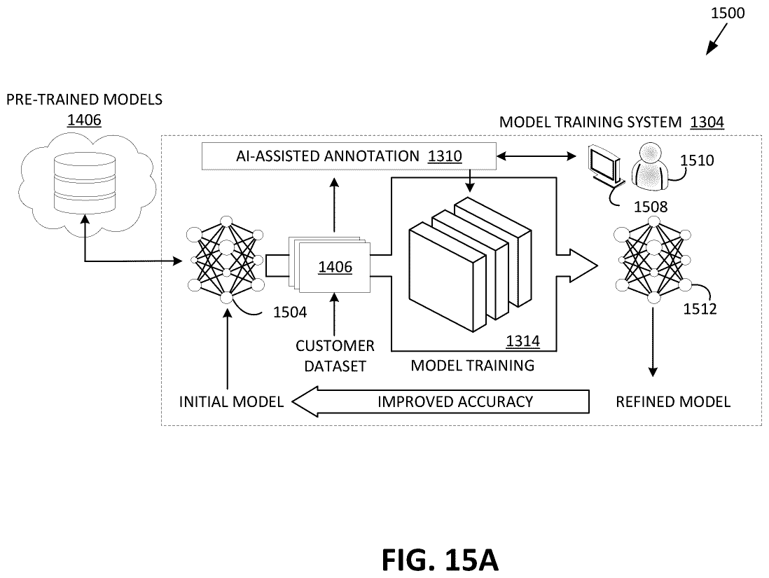

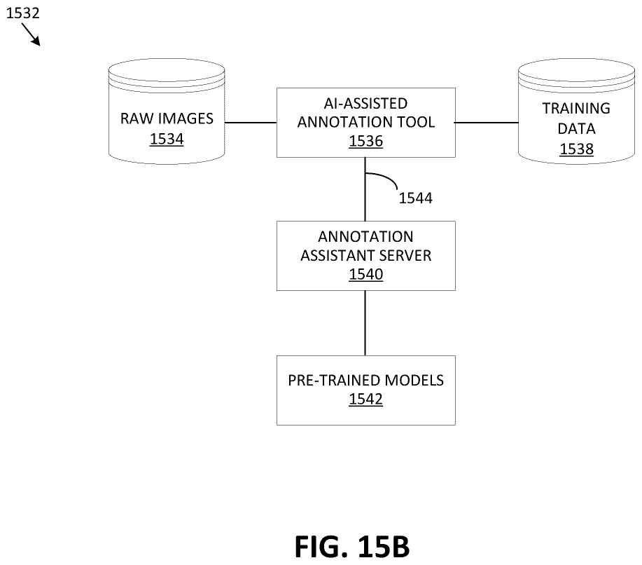

In at least one embodiment, training pipelines 1404 may include AI-assisted annotation, as described in more detail herein with respect to at least FIG. 15B. In at least one embodiment, labeled data 1312 (e.g., traditional annotation) may be generated by any number of techniques. In at least one embodiment, labels or other annotations may be generated within a drawing program (e.g., an annotation program), a computer aided design (CAD) program, a labeling program, another type of program suitable for generating annotations or labels for ground truth, and/or may be hand drawn, in some examples. In at least one embodiment, ground truth data may be synthetically produced (e.g., generated from computer models or renderings), real produced (e.g., designed and produced from real-world data), machine-automated (e.g., using feature analysis and learning to extract features from data and then generate labels), human annotated (e.g., labeler, or annotation expert, defines location of labels), and/or a combination thereof. In at least one embodiment, for each instance of imaging data 1308 (or other data type used by machine learning models), there may be corresponding ground truth data generated by training system 1304. In at least one embodiment, AI-assisted annotation may be performed as part of deployment pipelines 1410; either in addition to, or in lieu of AI-assisted annotation included in training pipelines 1404. In at least one embodiment, system 1400 may include a multi-layer platform that may include a software layer (e.g., software 1318) of diagnostic applications (or other application types) that may perform one or more medical imaging and diagnostic functions. In at least one embodiment, system 1400 may be communicatively coupled to (e.g., via encrypted links) PACS server networks of one or more facilities. In at least one embodiment, system 1400 may be configured to access and referenced data from PACS servers to perform operations, such as training machine learning models, deploying machine learning models, image processing, inferencing, and/or other operations.

In at least one embodiment, a software layer may be implemented as a secure, encrypted, and/or authenticated API through which applications or containers may be invoked (e.g., called) from an external environment(s) (e.g., facility 1302). In at least one embodiment, applications may then call or execute one or more services 1320 for performing compute, AI, or visualization tasks associated with respective applications, and software 1318 and/or services 1320 may leverage hardware 1322 to perform processing tasks in an effective and efficient manner.

In at least one embodiment, deployment system 1306 may execute deployment pipelines 1410. In at least one embodiment, deployment pipelines 1410 may include any number of applications that may be sequentially, non-sequentially, or otherwise applied to imaging data (and/or other data types) generated by imaging devices, sequencing devices, genomics devices, etc.—including AI-assisted annotation, as described above. In at least one embodiment, as described herein, a deployment pipeline 1410 for an individual device may be referred to as a virtual instrument for a device (e.g., a virtual ultrasound instrument, a virtual CT scan instrument, a virtual sequencing instrument, etc.). In at least one embodiment, for a single device, there may be more than one deployment pipeline 1410 depending on information desired from data generated by a device. In at least one embodiment, where detections of anomalies are desired from an MRI machine, there may be a first deployment pipeline 1410, and where image enhancement is desired from output of an MRI machine, there may be a second deployment pipeline 1410.

In at least one embodiment, an image generation application may include a processing task that includes use of a machine learning model. In at least one embodiment, a user may desire to use their own machine learning model, or to select a machine learning model from model registry 1324. In at least one embodiment, a user may implement their own machine learning model or select a machine learning model for inclusion in an application for performing a processing task. In at least one embodiment, applications may be selectable and customizable, and by defining constructs of applications, deployment and implementation of applications for a particular user are presented as a more seamless user experience. In at least one embodiment, by leveraging other features of system 1400—such as services 1320 and hardware 1322—deployment pipelines 1410 may be even more user friendly, provide for easier integration, and produce more accurate, efficient, and timely results.

In at least one embodiment, deployment system 1306 may include a user interface 1414 (e.g., a graphical user interface, a web interface, etc.) that may be used to select applications for inclusion in deployment pipeline(s) 1410, arrange applications, modify or change applications or parameters or constructs thereof, use and interact with deployment pipeline(s) 1410 during set-up and/or deployment, and/or to otherwise interact with deployment system 1306. In at least one embodiment, although not illustrated with respect to training system 1304, user interface 1414 (or a different user interface) may be used for selecting models for use in deployment system 1306, for selecting models for training, or retraining, in training system 1304, and/or for otherwise interacting with training system 1304.

In at least one embodiment, pipeline manager 1412 may be used, in addition to an application orchestration system 1428, to manage interaction between applications or containers of deployment pipeline(s) 1410 and services 1320 and/or hardware 1322. In at least one embodiment, pipeline manager 1412 may be configured to facilitate interactions from application to application, from application to service 1320, and/or from application or service to hardware 1322. In at least one embodiment, although illustrated as included in software 1318, this is not intended to be limiting, and in some examples (e.g., as illustrated in FIG. 12cc) pipeline manager 1412 may be included in services 1320. In at least one embodiment, application orchestration system 1428 (e.g., Kubernetes, DOCKER, etc.) may include a container orchestration system that may group applications into containers as logical units for coordination, management, scaling, and deployment. In at least one embodiment, by associating applications from deployment pipeline(s) 1410 (e.g., a reconstruction application, a segmentation application, etc.) with individual containers, each application may execute in a self-contained environment (e.g., at a kernel level) to increase speed and efficiency.

In at least one embodiment, each application and/or container (or image thereof) may be individually developed, modified, and deployed (e.g., a first user or developer may develop, modify, and deploy a first application and a second user or developer may develop, modify, and deploy a second application separate from a first user or developer), which may allow for focus on, and attention to, a task of a single application and/or container(s) without being hindered by tasks of another application(s) or container(s). In at least one embodiment, communication, and cooperation between different containers or applications may be aided by pipeline manager 1412 and application orchestration system 1428. In at least one embodiment, so long as an expected input and/or output of each container or application is known by a system (e.g., based on constructs of applications or containers), application orchestration system 1428 and/or pipeline manager 1412 may facilitate communication among and between, and sharing of resources among and between, each of applications or containers. In at least one embodiment, because one or more of applications or containers in deployment pipeline(s) 1410 may share same services and resources, application orchestration system 1428 may orchestrate, load balance, and determine sharing of services or resources between and among various applications or containers. In at least one embodiment, a scheduler may be used to track resource requirements of applications or containers, current usage or planned usage of these resources, and resource availability. In at least one embodiment, a scheduler may thus allocate resources to different applications and distribute resources between and among applications in view of requirements and availability of a system. In some examples, a scheduler (and/or other component of application orchestration system 1428) may determine resource availability and distribution based on constraints imposed on a system (e.g., user constraints), such as quality of service (QoS), urgency of need for data outputs (e.g., to determine whether to execute real-time processing or delayed processing), etc.

In at least one embodiment, services 1320 leveraged by and shared by applications or containers in deployment system 1306 may include compute services 1416, AI services 1418, visualization services 1420, and/or other service types. In at least one embodiment, applications may call (e.g., execute) one or more of services 1320 to perform processing operations for an application. In at least one embodiment, compute services 1416 may be leveraged by applications to perform super-computing or other high-performance computing (HPC) tasks. In at least one embodiment, compute service(s) 1416 may be leveraged to perform parallel processing (e.g., using a parallel computing platform 1430) for processing data through one or more of applications and/or one or more tasks of a single application, substantially simultaneously. In at least one embodiment, parallel computing platform 1430 (e.g., NVIDIA's CUDA) may enable general purpose computing on GPUs (GPGPU) (e.g., GPUs 1422). In at least one embodiment, a software layer of parallel computing platform 1430 may provide access to virtual instruction sets and parallel computational elements of GPUs, for execution of compute kernels. In at least one embodiment, parallel computing platform 1430 may include memory and, in some embodiments, a memory may be shared between and among multiple containers, and/or between and among different processing tasks within a single container. In at least one embodiment, inter-process communication (IPC) calls may be generated for multiple containers and/or for multiple processes within a container to use same data from a shared segment of memory of parallel computing platform 1430 (e.g., where multiple different stages of an application or multiple applications are processing same information). In at least one embodiment, rather than making a copy of data and moving data to different locations in memory (e.g., a read/write operation), same data in same location of a memory may be used for any number of processing tasks (e.g., at a same time, at different times, etc.). In at least one embodiment, as data is used to generate new data as a result of processing, this information of a new location of data may be stored and shared between various applications. In at least one embodiment, location of data and a location of updated or modified data may be part of a definition of how a payload is understood within containers.

In at least one embodiment, AI services 1418 may be leveraged to perform inferencing services for executing machine learning model(s) associated with applications (e.g., tasked with performing one or more processing tasks of an application). In at least one embodiment, AI services 1418 may leverage AI system 1424 to execute machine learning model(s) (e.g., neural networks, such as CNNs) for segmentation, reconstruction, object detection, feature detection, classification, and/or other inferencing tasks. In at least one embodiment, applications of deployment pipeline(s) 1410 may use one or more of output models 1316 from training system 1304 and/or other models of applications to perform inference on imaging data. In at least one embodiment, two or more examples of inferencing using application orchestration system 1428 (e.g., a scheduler) may be available. In at least one embodiment, a first category may include a high priority/low latency path that may achieve higher service level agreements, such as for performing inference on urgent requests during an emergency, or for a radiologist during diagnosis. In at least one embodiment, a second category may include a standard priority path that may be used for requests that may be non-urgent or where analysis may be performed at a later time. In at least one embodiment, application orchestration system 1428 may distribute resources (e.g., services 1320 and/or hardware 1322) based on priority paths for different inferencing tasks of AI services 1418.

In at least one embodiment, shared storage may be mounted to AI services 1418 within system 1400. In at least one embodiment, shared storage may operate as a cache (or other storage device type) and may be used to process inference requests from applications. In at least one embodiment, when an inference request is submitted, a request may be received by a set of API instances of deployment system 1306, and one or more instances may be selected (e.g., for best fit, for load balancing, etc.) to process a request. In at least one embodiment, to process a request, a request may be entered into a database, a machine learning model may be located from model registry 1324 if not already in a cache, a validation step may ensure appropriate machine learning model is loaded into a cache (e.g., shared storage), and/or a copy of a model may be saved to a cache. In at least one embodiment, a scheduler (e.g., of pipeline manager 1412) may be used to launch an application that is referenced in a request if an application is not already running or if there are not enough instances of an application. In at least one embodiment, if an inference server is not already launched to execute a model, an inference server may be launched. Any number of inference servers may be launched per model. In at least one embodiment, in a pull model, in which inference servers are clustered, models may be cached whenever load balancing is advantageous. In at least one embodiment, inference servers may be statically loaded in corresponding, distributed servers.

In at least one embodiment, inferencing may be performed using an inference server that runs in a container. In at least one embodiment, an instance of an inference server may be associated with a model (and optionally a plurality of versions of a model). In at least one embodiment, if an instance of an inference server does not exist when a request to perform inference on a model is received, a new instance may be loaded. In at least one embodiment, when starting an inference server, a model may be passed to an inference server such that a same container may be used to serve different models so long as inference server is running as a different instance.

In at least one embodiment, during application execution, an inference request for a given application may be received, and a container (e.g., hosting an instance of an inference server) may be loaded (if not already), and a start procedure may be called. In at least one embodiment, pre-processing logic in a container may load, decode, and/or perform any additional pre-processing on incoming data (e.g., using a CPU(s) and/or GPU(s)). In at least one embodiment, once data is prepared for inference, a container may perform inference as necessary on data. In at least one embodiment, this may include a single inference call on one image (e.g., a hand X-ray), or may require inference on hundreds of images (e.g., a chest CT). In at least one embodiment, an application may summarize results before completing, which may include, without limitation, a single confidence score, pixel level-segmentation, voxel-level segmentation, generating a visualization, or generating text to summarize findings. In at least one embodiment, different models or applications may be assigned different priorities. For example, some models may have a real-time (TAT <1 min) priority while others may have lower priority (e.g., TAT <10 min). In at least one embodiment, model execution times may be measured from requesting institution or entity and may include partner network traversal time, as well as execution on an inference service.

In at least one embodiment, transfer of requests between services 1320 and inference applications may be hidden behind a software development kit (SDK), and robust transport may be provide through a queue. In at least one embodiment, a request will be placed in a queue via an API for an individual application/tenant ID combination and an SDK will pull a request from a queue and give a request to an application. In at least one embodiment, a name of a queue may be provided in an environment from where an SDK will pick it up. In at least one embodiment, asynchronous communication through a queue may be useful as it may allow any instance of an application to pick up work as it becomes available. Results may be transferred back through a queue, to ensure no data is lost. In at least one embodiment, queues may also provide an ability to segment work, as highest priority work may go to a queue with most instances of an application connected to it, while lowest priority work may go to a queue with a single instance connected to it that processes tasks in an order received. In at least one embodiment, an application may run on a GPU-accelerated instance generated in cloud 1426, and an inference service may perform inferencing on a GPU.

In at least one embodiment, visualization services 1420 may be leveraged to generate visualizations for viewing outputs of applications and/or deployment pipeline(s) 1410. In at least one embodiment, GPUs 1422 may be leveraged by visualization services 1420 to generate visualizations. In at least one embodiment, rendering effects, such as ray-tracing, may be implemented by visualization services 1420 to generate higher quality visualizations. In at least one embodiment, visualizations may include, without limitation, 2D image renderings, 3D volume renderings, 3D volume reconstruction, 2D tomographic slices, virtual reality displays, augmented reality displays, etc. In at least one embodiment, virtualized environments may be used to generate a virtual interactive display or environment (e.g., a virtual environment) for interaction by users of a system (e.g., doctors, nurses, radiologists, etc.). In at least one embodiment, visualization services 1420 may include an internal visualizer, cinematics, and/or other rendering or image processing capabilities or functionality (e.g., ray tracing, rasterization, internal optics, etc.).

In at least one embodiment, hardware 1322 may include GPUs 1422, AI system 1424, cloud 1426, and/or any other hardware used for executing training system 1304 and/or deployment system 1306. In at least one embodiment, GPUs 1422 (e.g., NVIDIA's TESLA and/or QUADRO GPUs) may include any number of GPUs that may be used for executing processing tasks of compute services 1416, AI services 1418, visualization services 1420, other services, and/or any of features or functionality of software 1318. For example, with respect to AI services 1418, GPUs 1422 may be used to perform pre-processing on imaging data (or other data types used by machine learning models), post-processing on outputs of machine learning models, and/or to perform inferencing (e.g., to execute machine learning models). In at least one embodiment, cloud 1426, AI system 1424, and/or other components of system 1400 may use GPUs 1422. In at least one embodiment, cloud 1426 may include a GPU-optimized platform for deep learning tasks. In at least one embodiment, AI system 1424 may use GPUs, and cloud 1426—or at least a portion tasked with deep learning or inferencing—may be executed using one or more AI systems 1424. As such, although hardware 1322 is illustrated as discrete components, this is not intended to be limiting, and any components of hardware 1322 may be combined with, or leveraged by, any other components of hardware 1322.

In at least one embodiment, AI system 1424 may include a purpose-built computing system (e.g., a super-computer or an HPC) configured for inferencing, deep learning, machine learning, and/or other artificial intelligence tasks. In at least one embodiment, AI system 1424 (e.g., NVIDIA's DGX) may include GPU-optimized software (e.g., a software stack) that may be executed using a plurality of GPUs 1422, in addition to CPUs, RAM, storage, and/or other components, features, or functionality. In at least one embodiment, one or more AI systems 1424 may be implemented in cloud 1426 (e.g., in a data center) for performing some or all of AI-based processing tasks of system 1400.

In at least one embodiment, cloud 1426 may include a GPU-accelerated infrastructure (e.g., NVIDIA's NGC) that may provide a GPU-optimized platform for executing processing tasks of system 1400. In at least one embodiment, cloud 1426 may include an AI system(s) 1424 for performing one or more of AI-based tasks of system 1400 (e.g., as a hardware abstraction and scaling platform). In at least one embodiment, cloud 1426 may integrate with application orchestration system 1428 leveraging multiple GPUs to enable seamless scaling and load balancing between and among applications and services 1320. In at least one embodiment, cloud 1426 may tasked with executing at least some of services 1320 of system 1400, including compute services 1416, AI services 1418, and/or visualization services 1420, as described herein. In at least one embodiment, cloud 1426 may perform small and large batch inference (e.g., executing NVIDIA's TENSOR RT), provide an accelerated parallel computing API and platform 1430 (e.g., NVIDIA's CUDA), execute application orchestration system 1428 (e.g., KUBERNETES), provide a graphics rendering API and platform (e.g., for ray-tracing, 2D graphics, 3D graphics, and/or other rendering techniques to produce higher quality cinematics), and/or may provide other functionality for system 1400.

FIG. 15A illustrates a data flow diagram for a process 1500 to train, retrain, or update a machine learning model, in accordance with at least one embodiment. In at least one embodiment, process 1500 may be executed using, as a non-limiting example, system 1400 of FIG. 14. In at least one embodiment, process 1500 may leverage services 1320 and/or hardware 1322 of system 1400, as described herein. In at least one embodiment, refined models 1512 generated by process 1500 may be executed by deployment system 1306 for one or more containerized applications in deployment pipelines 1410.

In at least one embodiment, model training 1314 may include retraining or updating an initial model 1504 (e.g., a pre-trained model) using new training data (e.g., new input data, such as customer dataset 1506, and/or new ground truth data associated with input data). In at least one embodiment, to retrain, or update, initial model 1504, output or loss layer(s) of initial model 1504 may be reset, or deleted, and/or replaced with an updated or new output or loss layer(s). In at least one embodiment, initial model 1504 may have previously fine-tuned parameters (e.g., weights and/or biases) that remain from prior training, so training or retraining 1314 may not take as long or require as much processing as training a model from scratch. In at least one embodiment, during model training 1314, by having reset or replaced output or loss layer(s) of initial model 1504, parameters may be updated and re-tuned for a new data set based on loss calculations associated with accuracy of output or loss layer(s) at generating predictions on new, customer dataset 1506 (e.g., image data 1308 of FIG. 13).

In at least one embodiment, pre-trained models 1406 may be stored in a data store, or registry (e.g., model registry 1324 of FIG. 13). In at least one embodiment, pre-trained models 1406 may have been trained, at least in part, at one or more facilities other than a facility executing process 1500. In at least one embodiment, to protect privacy and rights of patients, subjects, or clients of different facilities, pre-trained models 1406 may have been trained, on-premise, using customer or patient data generated on-premise. In at least one embodiment, pre-trained models 1406 may be trained using cloud 1426 and/or other hardware 1322, but confidential, privacy protected patient data may not be transferred to, used by, or accessible to any components of cloud 1426 (or other off premise hardware). In at least one embodiment, where a pre-trained model 1406 is trained at using patient data from more than one facility, pre-trained model 1406 may have been individually trained for each facility prior to being trained on patient or customer data from another facility. In at least one embodiment, such as where a customer or patient data has been released of privacy concerns (e.g., by waiver, for experimental use, etc.), or where a customer or patient data is included in a public data set, a customer or patient data from any number of facilities may be used to train pre-trained model 1406 on-premise and/or off premise, such as in a datacenter or other cloud computing infrastructure.

In at least one embodiment, when selecting applications for use in deployment pipelines 1410, a user may also select machine learning models to be used for specific applications. In at least one embodiment, a user may not have a model for use, so a user may select a pre-trained model 1406 to use with an application. In at least one embodiment, pre-trained model 1406 may not be optimized for generating accurate results on customer dataset 1506 of a facility of a user (e.g., based on patient diversity, demographics, types of medical imaging devices used, etc.). In at least one embodiment, prior to deploying pre-trained model 1406 into deployment pipeline 1410 for use with an application(s), pre-trained model 1406 may be updated, retrained, and/or fine-tuned for use at a respective facility.

In at least one embodiment, a user may select pre-trained model 1406 that is to be updated, retrained, and/or fine-tuned, and pre-trained model 1406 may be referred to as initial model 1504 for training system 1304 within process 1500. In at least one embodiment, customer dataset 1506 (e.g., imaging data, genomics data, sequencing data, or other data types generated by devices at a facility) may be used to perform model training 1314 (which may include, without limitation, transfer learning) on initial model 1504 to generate refined model 1512. In at least one embodiment, ground truth data corresponding to customer dataset 1506 may be generated by training system 1304. In at least one embodiment, ground truth data may be generated, at least in part, by clinicians, scientists, doctors, practitioners, at a facility (e.g., as labeled clinic data 1312 of FIG. 13).

In at least one embodiment, AI-assisted annotation 1310 may be used in some examples to generate ground truth data. In at least one embodiment, AI-assisted annotation 1310 (e.g., implemented using an AI-assisted annotation SDK) may leverage machine learning models (e.g., neural networks) to generate suggested or predicted ground truth data for a customer dataset. In at least one embodiment, user 1510 may use annotation tools within a user interface (a graphical user interface (GUI)) on computing device 1508.

In at least one embodiment, user 1510 may interact with a GUI via computing device 1508 to edit or fine-tune (auto)annotations. In at least one embodiment, a polygon editing feature may be used to move vertices of a polygon to more accurate or fine-tuned locations.

In at least one embodiment, once customer dataset 1506 has associated ground truth data, ground truth data (e.g., from AI-assisted annotation, manual labeling, etc.) may be used by during model training 1314 to generate refined model 1512. In at least one embodiment, customer dataset 1506 may be applied to initial model 1504 any number of times, and ground truth data may be used to update parameters of initial model 1504 until an acceptable level of accuracy is attained for refined model 1512. In at least one embodiment, once refined model 1512 is generated, refined model 1512 may be deployed within one or more deployment pipelines 1410 at a facility for performing one or more processing tasks with respect to medical imaging data.

In at least one embodiment, refined model 1512 may be uploaded to pre-trained models 1406 in model registry 1324 to be selected by another facility. In at least one embodiment, his process may be completed at any number of facilities such that refined model 1512 may be further refined on new datasets any number of times to generate a more universal model.

FIG. 15B is an example illustration of a client-server architecture 1532 to enhance annotation tools with pre-trained annotation models, in accordance with at least one embodiment. In at least one embodiment, AI-assisted annotation tools 1536 may be instantiated based on a client-server architecture 1532. In at least one embodiment, annotation tools 1536 in imaging applications may aid radiologists, for example, identify organs and abnormalities. In at least one embodiment, imaging applications may include software tools that help user 1510 to identify, as a non-limiting example, a few extreme points on a particular organ of interest in raw images 1534 (e.g., in a 3D MRI or CT scan) and receive auto-annotated results for all 2D slices of a particular organ. In at least one embodiment, results may be stored in a data store as training data 1538 and used as (for example and without limitation) ground truth data for training. In at least one embodiment, when computing device 1508 sends extreme points for AI-assisted annotation 1310, a deep learning model, for example, may receive this data as input and return inference results of a segmented organ or abnormality. In at least one embodiment, pre-instantiated annotation tools, such as AI-Assisted Annotation Tool 1536B in FIG. 15B, may be enhanced by making API calls (e.g., API Call 1544) to a server, such as an Annotation Assistant Server 1540 that may include a set of pre-trained models 1542 stored in an annotation model registry, for example. In at least one embodiment, an annotation model registry may store pre-trained models 1542 (e.g., machine learning models, such as deep learning models) that are pre-trained to perform AI-assisted annotation on a particular organ or abnormality. These models may be further updated by using training pipelines 1404. In at least one embodiment, pre-installed annotation tools may be improved over time as new labeled clinic data 1312 is added.

Such components can be used to generate synthetic data imitating failure cases in a network training process, which can help to improve performance of the network while limiting the amount of synthetic data to avoid overfitting.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. Term “connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. Use of term “set” (e.g., “a set of items”) or “subset,” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B, and at least one of C each to be present. In addition, unless otherwise noted or contradicted by context, term “plurality” indicates a state of being plural (e.g., “a plurality of items” indicates multiple items). A plurality is at least two items, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. A set of non-transitory computer-readable storage media, in at least one embodiment, comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. Terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. Obtaining, acquiring, receiving, or inputting analog and digital data can be accomplished in a variety of ways such as by receiving data as a parameter of a function call or a call to an application programming interface. In some implementations, process of obtaining, acquiring, receiving, or inputting analog or digital data can be accomplished by transferring data via a serial or parallel interface. In another implementation, process of obtaining, acquiring, receiving, or inputting analog or digital data can be accomplished by transferring data via a computer network from providing entity to acquiring entity. References may also be made to providing, outputting, transmitting, sending, or presenting analog or digital data. In various examples, process of providing, outputting, transmitting, sending, or presenting analog or digital data can be accomplished by transferring data as an input or output parameter of a function call, a parameter of an application programming interface or interprocess communication mechanism.

Although discussion above sets forth example implementations of described techniques, other architectures may be used to implement described functionality, and are intended to be within scope of this disclosure. Furthermore, although specific distributions of responsibilities are defined above for purposes of discussion, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A method comprising:
identifying, using a client-side update component, one or more provisioned resources of a plurality of nodes of a remote data center;
for at least one provisioned resource of the one or more provisioned resources, identifying, using the client-side component, an available update of the at least one provisioned resource based at least on a resource graph associated with the at least one provisioned resource, the resource graph depicting one or more update paths of the at least one provisioned resource; and
responsive to identifying the available update, providing, using the client-side component, a custom resource definition associated with the available update of the at least one provisioned resource to a custom controller associated with the at least one provisioned resource to update at least one node of the plurality of nodes of the data center using the available update of the at least one provisioned resource.

2. The method of claim 1, wherein identifying, using the client-side component, the available update of the at least one provisioned resource based at least on the resource graph associated with the at least one provisioned resource depicting one or more update paths of the provisioned resource comprises:
periodically querying, using the client-side update component of the update framework, a policy engine of a server-side update component of the update framework to obtain the resource graph associated with the at least one provisioned resource;
returning, using the policy engine, the resource graph associated with the at least one provisioned resource to the client-side component.

3. The method of claim 2, wherein returning, using the policy engine, the resource graph associated with the at least one provisioned resource to the client-side update component comprises:
requesting, using the policy engine, the resource graph associated with the at least one provisioned resource from a graph builder of the client-side update component based on one or more release pointers associated with at least one version of the provisioned resource;
applying, using the policy engine, one or more policy definitions to the resource graph; and
providing, using the policy engine, the resource graph to the client-side component.

4. The method of claim 3, wherein requesting, using the policy engine, the resource graph associated with the at least one provisioned resource from the graph builder comprises:
retrieving one or more release pointers associated with one or more versions of the at least one provisioned resource from a release pointer artifact repository; and
generating the resource graph by linearly ordering, based on each version of the one or more versions of the at least one provisioned resource, the retrieved one or more release pointers corresponding to the at least one provisioned resource.

5. The method of claim 1, wherein identifying, using the client-side component, an available update of the at least one provisioned resource based on a resource graph associated with the at least one provisioned resource depicting one or more update paths of the at least one provisioned resource comprises:
identifying a current version of the at least one provisioned resource;
locating the current version of the at least one provisioned resource in the resource graph associated with the at least one provisioned resource; and
identifying a subsequent version of the at least one provisioned resource in the resource graph after the current version of the at least one provisioned resource.

6. The method of claim 1, wherein the client-side update component is instantiated using one or more remote Kubernetes clusters of the remote data center.

7. The method of claim 2, wherein the server-side update component is separate from the remote data center.

8. A system comprising:
a processing device to perform operations comprising:
identifying, using a client-side update component of an update framework, one or more provisioned resources of a plurality of nodes of a remote data center;
for at least one provisioned resource of the one or more provisioned resources, identifying, using the client-side component, an available update of the at least one provisioned resource based at least on a resource graph associated with the at least one provisioned resource, the resource graph depicting one or more update paths of the at least one provisioned resource; and
responsive to identifying the available update, providing, using the client-side component, a custom resource definition associated with the available update of the at least one provisioned resource to a custom controller associated with the at least one provisioned resource to update at least one node of the plurality of nodes of the data center with the update of the at least one provisioned resource.

9. The system of claim 8, wherein identifying, using the client-side component, the available update of the at least one provisioned resource based at least on the resource graph associated with the at least one provisioned resource comprises:
periodically querying, using the client-side update component of the update framework, a policy engine of a server-side update component of the update framework to obtain the resource graph associated with the at least one provisioned resource;
returning, using the policy engine, the resource graph associated with the at least one provisioned resource to the client-side component.

10. The system of claim 9, wherein returning, using the policy engine, the resource graph associated with the at least one provisioned resource to the client-side update component comprises:
requesting, using the policy engine, the resource graph associated with the at least one provisioned resource from a graph builder of the client-side update component based at least on one or more release pointers associated with at least one version of the at least one provisioned resource;
applying, using the policy engine, one or more policy definitions to the resource graph; and
providing, using the policy engine, the resource graph to the client-side component.

11. The system of claim 10, wherein requesting, using the policy engine, the resource graph associated with the at least one provisioned resource from the graph builder comprises:
retrieving one or more release pointers associated with at least one version of the at least one provisioned resource from a release pointer artifact repository; and
generating the resource graph by linearly ordering, based at least on at least one version of the at least one provisioned resource, the retrieved one or more release pointers of the at least one provisioned resource.

12. The system of claim 8, wherein identifying, using the client-side component, an available update of the provisioned resource based on a resource graph associated with the at least one provisioned resource depicting one or more update paths of the at least one provisioned resource comprises:
identifying a current version of the at least one provisioned resource;
locating the current version of the at least one provisioned resource in the resource graph associated with the at least one provisioned resource; and
identifying a subsequent version of the at least one provisioned resource in the resource graph after the current version of the at least one provisioned resource.

13. The system of claim 8, wherein the client-side update component is instantiated using one or more remote Kubernetes clusters of the remote data center.

14. The system of claim 9, wherein the server-side update component is separate from the remote data center.

15. A circuit comprising:
one or more processors to implement an update framework to periodically check for updates of one or more resources of a remote data center and performing over-the-air (OTA) updates to the one or more resources.

16. The circuit of claim 15, wherein the update framework comprises a combination of one or more client-side components and one or more server-side components.

17. The circuit of claim 16, wherein the client-side components comprises at least one of:
a cluster version operator (CVO) to perform periodic checks for updates from a policy engine server; or
a second-level operator (SLO) to perform service updates.

18. The circuit of claim 17, wherein the CVO is instantiated using one or more remote Kubernetes clusters.

19. The circuit of claim 16, wherein the server-side components comprises at least one of:
a policy engine to query a container artifact repository for one or more release pointers associated with at least one resource of the one or more resources; or
a graph builder to generate one or more directed graphs that represent one or more eligible version for the one or more resources of a given cluster based at least in part on the one or more release pointer from the policy engine.

20. The circuit of claim 16, wherein the client-side components communicates with the server-side components via a side car container of the server-side components.
